(19) United States
(12) Patent Application Publication
(10) Pub. No.: US 2017/0286114 A1
(43) Pub. Date: Oct. 5, 2017

(54) PROCESSORS, METHODS, AND SYSTEMS TO ALLOCATE LOAD AND STORE BUFFERS BASED ON INSTRUCTION TYPE

(71) Applicant: Intel Corporation, Santa Clara, CA (US)

(72) Inventors: Andrew J. Herdrich, Hillsboro, OR (US); Yipeng Wang, Beaverton, OR (US); Ren Wang, Portland, OR (US); Tsung-Yuan Charles Tai, Portland, OR (US); Jr-Shian Tsai, Portland, OR (US)

(73) Assignee: Intel Corporation, Santa Clara, CA (US)

(21) Appl. No.: 15/089,533

(22) Filed: Apr. 2, 2016

(51) Int. Cl. G06F 9/30; G06F 12/08; G06F 3/06

(52) U.S. Cl. CPC G06F 9/30043; G06F 9/3016; G06F 3/061; G06F 3/0656; G06F 3/0673; G06F 12/0802; G06F 2212/602

(57) ABSTRACT

A processor of an aspect includes a decode unit to decode memory access instructions of a first type and to output corresponding memory access operations, and to decode memory access instructions of a second type and to output corresponding memory access operations. The processor also includes a load store queue coupled with the decode unit. The load store queue includes a load buffer that is to have a plurality of load buffer entries, and a store buffer that is to have a plurality of store buffer entries. The load store queue also includes a buffer entry allocation controller coupled with the load buffer and coupled with the store buffer. The buffer entry allocation controller is to allocate load and store buffer entries based at least in part on whether memory access operations correspond to memory access instructions of the first type or of the second type. Other processors, methods, and systems, are also disclosed.

### BACKGROUND

### Technical Field

Embodiments described herein generally relate to processors. In particular, embodiments described herein generally relate to performing memory access instructions with processors.

### Background Information

Processors are typically employed in systems that include memory. The processors generally have instruction sets that include instructions to access data in the memory. For example, the processors may have one or more load instructions that when performed cause the processor to load or read data from the memory. The processors may also have one or more store instructions that when performed cause the processor to write or store data to the memory. These instructions are often implemented with logic of a memory subsystem of the processor.

### BRIEF DESCRIPTION OF THE DRAWINGS

The invention may best be understood by referring to the following description and accompanying drawings that are used to illustrate embodiments. In the drawings:

FIG. 1 is a block diagram of an example embodiment of an instruction set for a processor.

FIG. 2 is a block flow diagram of an embodiment of a method of allocating load and store buffer entries.

FIG. 3 is a block diagram of an embodiment of a processor that is operative to perform memory access instructions of first and second types, and to allocate entries in load and store buffers based at least in part on whether memory access operations correspond to the memory access instructions of the first type or the second type.

FIG. 4 is a block diagram illustrating a detailed example embodiment of a load store queue.

FIG. 5 is a block flow diagram of an embodiment of a method of processing load operations corresponding memory access instructions of a second type when a bypass buffer is available.

FIG. 6 is a block flow diagram of an embodiment of a method of processing load operations corresponding memory access instructions of a second type when a bypass buffer is not available.

FIG. 7 is a block flow diagram of an embodiment of a method of processing store operations corresponding memory access instructions of a second type.

FIG. 8A is a block diagram illustrating an embodiment of an in-order pipeline and an embodiment of a register renaming out-of-order issue/execution pipeline.

FIG. 8B is a block diagram of an embodiment of processor core including a front end unit coupled to an execution engine unit and both coupled to a memory unit.

FIG. 9A is a block diagram of an embodiment of a single processor core, along with its connection to the on-die interconnect network, and with its local subset of the Level 2 (L2) cache.

FIG. 9B is a block diagram of an embodiment of an expanded view of part of the processor core of FIG. 9A.

FIG. 10 is a block diagram of an embodiment of a processor that may have more than one core, may have an integrated memory controller, and may have integrated graphics.

FIG. 11 is a block diagram of a first embodiment of a computer architecture.

FIG. 12 is a block diagram of a second embodiment of a computer architecture.

FIG. 13 is a block diagram of a third embodiment of a computer architecture.

FIG. 14 is a block diagram of a fourth embodiment of a computer architecture.

FIG. 15 is a block diagram of use of a software instruction converter to convert binary instructions in a source instruction set to binary instructions in a target instruction set, according to embodiments of the invention.

### DETAILED DESCRIPTION OF EMBODIMENTS

Disclosed herein are processors, methods, and systems to allocate load and store buffers and/or other memory subsystem resources based on memory access instruction type. In some embodiments, the processors may have a decode unit or other logic to receive and/or decode memory access instructions of first and second types, and a queue/buffer, controller, or other logic to sequence operations and/or allocate load and store buffers, or other memory subsystem resources, for operations based at least in part on whether the operations correspond to the memory access instructions of the first or second types. In the following description, numerous specific details are set forth (e.g., specific instructions, processor configurations, microarchitectural details, sequences of operations, etc.). However, embodiments may be practiced without these specific details. In other instances, well-known circuits, structures and techniques have not been shown in detail to avoid obscuring the understanding of the description.

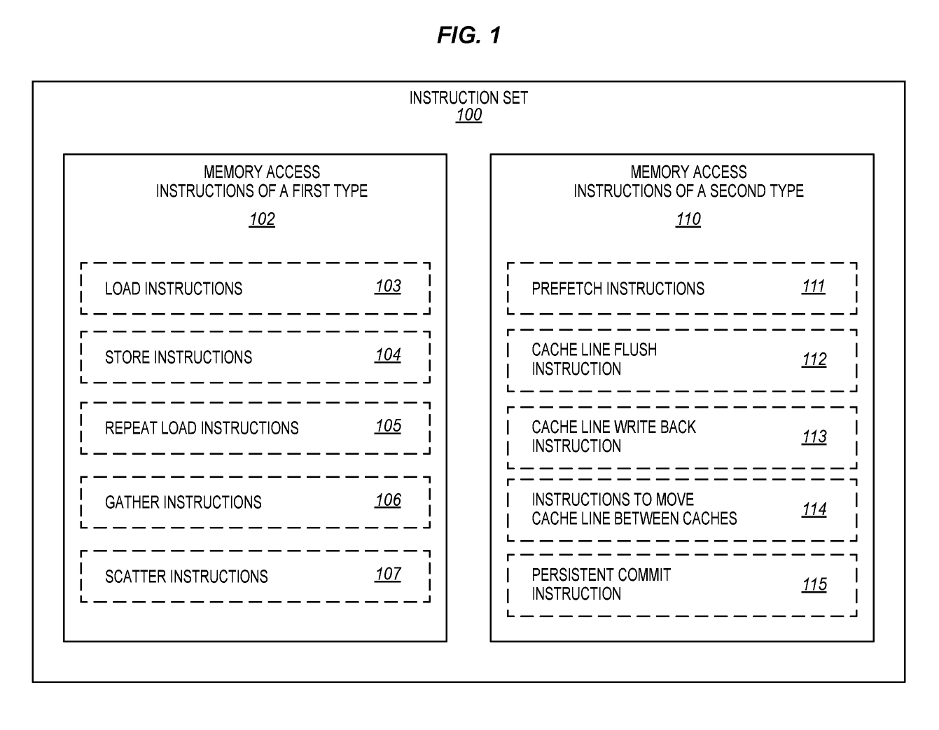

FIG. 1 is a block diagram of an example embodiment of an instruction set 100 for a processor with certain categories of instructions shown, though others are possible. The instruction set may include the macroinstructions, machine-level instructions, or other instructions or control signals that the processor is able to perform (e.g., decode and execute). The instruction set may include various different types of instructions, such as, for example, arithmetic instructions (e.g., multiplication instructions, addition instructions, etc.), logical instructions (e.g., logical AND instructions, logical OR instructions, shift instructions, rotate instructions, etc.), packed, vector, or single instruction, multiple data (SIMD) instructions (e.g., packed arithmetic instructions, packed logical instructions, etc.), cryptographic instructions, and various other types of instructions. Typically the instruction set also includes memory access instructions.

In some embodiments, the instruction set 100 may include two different types of memory access instructions. Specifically, the instruction set may include memory access instructions 102 of a first type, and memory access instructions 110 of a second, different type. Each of these memory access instructions may either perform a memory access (e.g., prefetch data from memory, load data from memory, or store data to memory), or may be related to performing a memory access (e.g., manage data in caches, guarantee that data from certain store operations has been stored in memory, etc.). As used herein, instructions to manage data in caches, and instructions to guarantee that data from certain store operations has been stored in memory, and the like, are regarded as memory access instructions, since they manage data from memory that has been cached (e.g., flush or writeback data from a cache to memory), affect memory access operations (e.g., guarantee that certain memory access operations have been performed), or the like.

To further illustrate certain concepts, a few representative examples of possible memory access instructions of the first type 102 are shown, although the scope of the invention is not limited to including all of these specific instructions, or just these specific instructions. In other embodiments, any one or more of these instructions, similar instructions, and potentially other instructions entirely, may optionally be included in the instruction set. As shown, the instructions of the first type may include one or more load instructions 103 that when performed may be operative to cause the processor to load data from an indicated memory location in memory and store the loaded data in an indicated destination register of the processor. The instructions of the first type may also include one or more store instructions 104 that when performed may be operative to cause the processor to store data from an indicated source register of the processor to an indicated memory location in the memory. Most modern day instruction sets include at least one such load instruction and at least one such store instruction, although the scope of the invention is not so limited.

In some cases, the memory access instructions of the first type may optionally include one or more repeat load instructions 105 that when performed may be operative to cause the processor to load multiple contiguous/sequential data elements (e.g., a string of data elements) from an indicated source memory location in the memory, and store the loaded multiple contiguous/sequential data elements back to an indicated destination memory location in the memory. In some cases, the memory access instructions of the first type may optionally include one or more gather instructions 106 that when performed may be operative to cause the processor to load multiple data elements from multiple potentially non-contiguous/non-sequential memory locations in the memory, which may each be indicated by a different corresponding memory index provided by (e.g., a source operand of) the gather instruction, and store the loaded data elements in an indicated destination packed data register of the processor. In some cases, the memory access instructions of the first type may optionally include one or more scatter instructions 107 that when performed may be operative to cause the processor to store multiple data elements from an indicated source packed data register of the processor to multiple potentially non-contiguous/non-sequential memory locations in the memory, which may each be indicated by a different corresponding memory index provided by (e.g., a source operand of) the scatter instruction. Each of these repeat load instructions, gather instructions, and scatter instructions, generally tend to be less common, and may or may not be included in any given instruction set.

A few representative examples of possible memory access instructions of the second type 110 are shown, although the scope of the invention is not limited to including all of these specific instructions, or just these specific instructions. In other embodiments, any one or more of these instructions, similar instructions, and potentially other instructions entirely, may optionally be included in the instruction set. As shown, the memory access instructions of the second type may include one or more prefetch instructions 111 that may serve as a hint or suggestion to the processor to prefetech data. The prefetch instructions if performed may be operative to cause the processor to prefetch data from an indicated memory location in the memory, and store the data in a cache hierarchy of the processor, but without storing the data in an architectural register of the processor. The memory access instructions of the second type may also include a cache line flush instruction 112 that when performed may be operative to cause the processor to flush a cache line corresponding to an indicated memory address of a source operand. The cache line may be invalidated in all levels of the processors cache hierarchy and the invalidation may be broadcast throughout the cache coherency domain. If at any level the cache line is inconsistent with system memory (e.g., dirty) it may be written to the system memory before invalidation. The memory access instructions of the second type may also include a cache line write back instruction 113 that when performed may be operative to cause the processor to write back a cache line (if dirty or inconsistent with system memory) corresponding to an indicated memory address of a source operand, and retain or invalidate the cache line in a cache hierarchy of the processor in a non-modified state. The cache line may be written back from any level of the processors cache hierarchy throughout the cache coherency domain.

The instructions of the second type may also include one or more instructions 114 to move a cache line between caches that when performed may be operative to cause the processor to move a cache line from a first cache in a cache coherency domain to a second cache in the cache coherency domain. As one possible example, a first instruction may be operative to cause the processor to push a cache line from a first cache close to a first core to a second cache close to a second core. As another possible example, a second instruction may be operative to cause the processor to demote or move a cache line from a first lower level cache (e.g. an L1 cache) close to a first core to a second higher level cache (e.g., an L3 cache). The instructions of the second type may also include a persistent commit instruction 115 that when performed may be operative to cause the processor to cause certain store-to-memory operations (e.g., those which have already been accepted to memory) to persistent memory ranges (e.g., non-volatile memory or power-failure backed volatile memory) to become persistent (e.g., power failure protected) before certain other store-to-memory operations (e.g., those which follow the persistent commit instruction or have not yet been accepted to memory when the persistent commit instruction is performed).

The load instruction(s) 103, the store instruction(s) 104, the repeat load instruction(s) 105, the gather instruction(s) 106, and the scatter instruction(s) 107, may each need to be performed (e.g., for correct execution), and may need to be performed in special order relative to each other and other instructions (e.g., may have relatively more strict sequencing and dependency rules than the instructions of the second type), in order for correct program execution. In contrast, the prefetch instruction(s) 111 and the instructions(s) to move cache lines between caches 114, may either not strictly need to be performed for correct execution and/or may not strictly need to be performed in a certain strict order for correct program execution (e.g., at least less strict sequencing and dependency rules than the instructions of the first type). These instructions represent special-purpose instructions that are designed to guide data movement into a cache hierarchy, out of the cache hierarchy, and/or move data around or within the cache hierarchy. For example, the prefetch instructions may merely represent hints that may be used to improve performance by helping to reduce cache misses. Similarly, the instructions(s) to move cache lines between caches may primarily seek to improve performance by moving data proactively to locations expected to be more efficient. At least at times, such prefetch instructions and instructions that move cache lines around in the caches could potentially be dropped without incorrect execution results. Also, the cache line flush instruction 112, the cache line write back instruction 113, and the persistent commit instruction may have relatively less dependency and ordering rules than the instructions of the first type and may be processed differently than the instructions of the first type as long as the generally lesser but needed sequencing and dependency rules are observed. For example, the cash line flush, cache line writeback, and persistent commit instructions may not be ordered with respect to any prefetch or fetch/load instructions, which may mean that data may be speculatively loaded into a cache line just before, during, or after the execution of a cache line write back, cache line flush, or instruction to move cache line between caches instruction that references the cache line. For these instructions, the content of the cache line does not change, but rather mainly the location where the cache line is allocated changes. Also the execution pipeline typically does not immediately rely on the completion of the cache line flush, cache line write back, and persistent commit instructions to proceed. These instructions are to improve the performance of the subsequent access of the cache line or move data in a specific fashion for correctness reasons. For example, a cache line flush instruction may remove a line from the cache hierarchy, and write it back to memory if the data has been modified. Such attributes permit improved ways of sequencing and/or allocating entries in load and store buffers especially for the prefetch instructions and the instructions to move data between caches, but also for the cache line write back instruction, the cache line flush instruction, and the persistent commit instruction (e.g., which may have more strict dependency and ordering rules than the prefetch and instructions to move cache lines between caches, but less strict dependency and ordering rules than the instructions of the first type), when implementation correctness and ordering requirements are adequately observed.

While the memory access instructions of the second type 110 may be useful and may help to improve performance, they may also consume valuable microarchitectural resources, such as, for example, load buffer entries, store buffer entries, reservation station entries, reorder buffer entries, and the like. For example, typically each prefetch instruction 111 may consume a load buffer entry in a load store queue while waiting to be satisfied. The cache line flush instruction 112, the cache line write back instruction 113, and the instruction(s) 114 to move cache lines between caches, may similarly be allocated to and consume store buffer entries in the load store queue. The persistent commit instruction 115 may also consume buffer entries, and may sometimes tend to have relatively long completion times (e.g., while waiting for implicated store operations to drain from the memory controllers to persistent storage) thereby consuming these resources for potentially relatively long times. Consequently, the memory access instructions of the second type may tend to contribute additional pressure on load and store buffers, and certain other microarchitectural resources of the memory subsystem of the processor. Especially when used in cache-intensive and/or memory-intensive applications, if such instructions are not well timed and/or well positioned in the code, then the fact that they may consume such microarchitectural resources, may in some cases reduce performance (e.g., by preventing the memory access instructions of the first type 102 from having greater access to these microarchitectural resources).

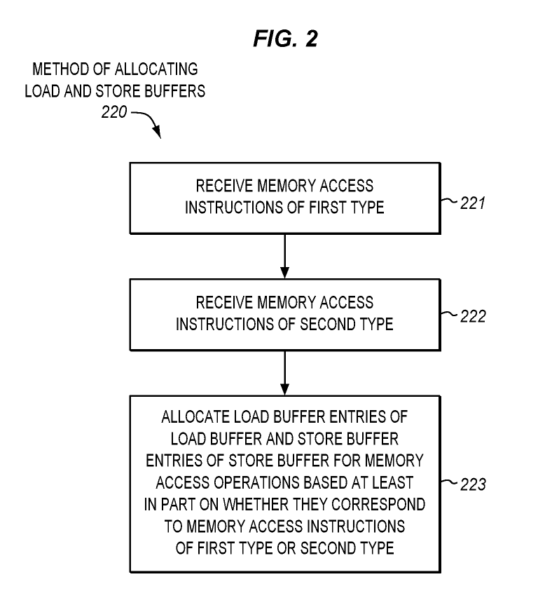

FIG. 2 is a block flow diagram of an embodiment of a method 220 of allocating load and store buffer entries. In various embodiments, the method may be performed by a processor, instruction processing apparatus, digital logic device, or integrated circuit.

The method includes receiving memory access instructions of a first type, at block 221. In some embodiments, these may include any one or more of the memory access instructions of the first type 102 as described for FIG. 1. The method also includes receiving memory access instructions of a second, different type, at block 222. In some embodiments, these may include any one or more of the memory access instructions of the second type 110 is described for FIG. 1. In various aspects, the instructions may be received at a processor, integrated circuit, or a portion thereof (e.g., an instruction cache, an instruction fetch unit, a decode unit, etc.). In various aspects, the instructions may be received from an off-processor and/or off-die source (e.g., from memory), or from an on-processor and/or on-die source (e.g., from an instruction cache, an instruction fetch unit, etc.).

At block 223, load buffer entries of a load buffer, and store buffer entries of a store buffer, may be allocated for memory access operations corresponding to the instructions of the first and second types, based at least in part on whether the memory access operations correspond to the memory access instructions of the first type or to the memory access instructions of the second type. In some embodiments, the allocation of entries in the load and store buffers may be performed differently for memory access operations that correspond to the instructions of the second type, as compared to the allocation of entries in the load and store buffers for the memory access operations that correspond to the instructions of the first type (and this may provide certain benefits). With regard to the allocation of entries in load and store buffers, the memory access operations corresponding to the instructions of the first and second types may be handled, treated, or processed differently.

In some embodiments, at least one entry in one of the load and store buffers may be unconditionally allocated to each of the memory access operations that correspond to the memory access instructions of the first type. In contrast, for the memory access operations that correspond to the memory access instructions of the second type, either an entry may not be allocated in the load and store buffers (e.g., in some embodiments unconditionally not allocated, or in other embodiments conditionally not allocated), or else an entry may be conditionally allocated in one of the load and store buffers, but only if one or more conditions are determined to be met or satisfied. In some embodiments, it may be determined whether or not to allocate an entry in one of the load and store buffers, for each of the memory access operations corresponding to the instructions of the second type, based in part on determining whether or not these one or more conditions are met or satisfied.

In some embodiments, such a determination may optionally be based on one or more, or any combination, of the following factors: (1) the current level of fullness, occupancy, or allocation of the load and/or store buffers (e.g., what proportion of the entries are already allocated to other operations); (2) whether the memory access operations corresponding to the instructions of the second type have any data dependencies with any memory access operations for which entries have already been allocated in the load and/or store buffers; (3) whether the memory access operations corresponding to the instructions of the second type can be output directly (e.g., sent to a level one (L1) data cache port) without being buffered; (4) whether there are resources currently available to directly and/or without delay (e.g., immediately) output the memory access operations corresponding to the instructions of the second type; (5) whether a bypass buffer exists that may be used instead of the load and store buffers for the memory access operations corresponding to the instructions of the second type. These are just a few examples. Other embodiments may use any one or more of these conditions optionally together with other conditions, or different conditions entirely.

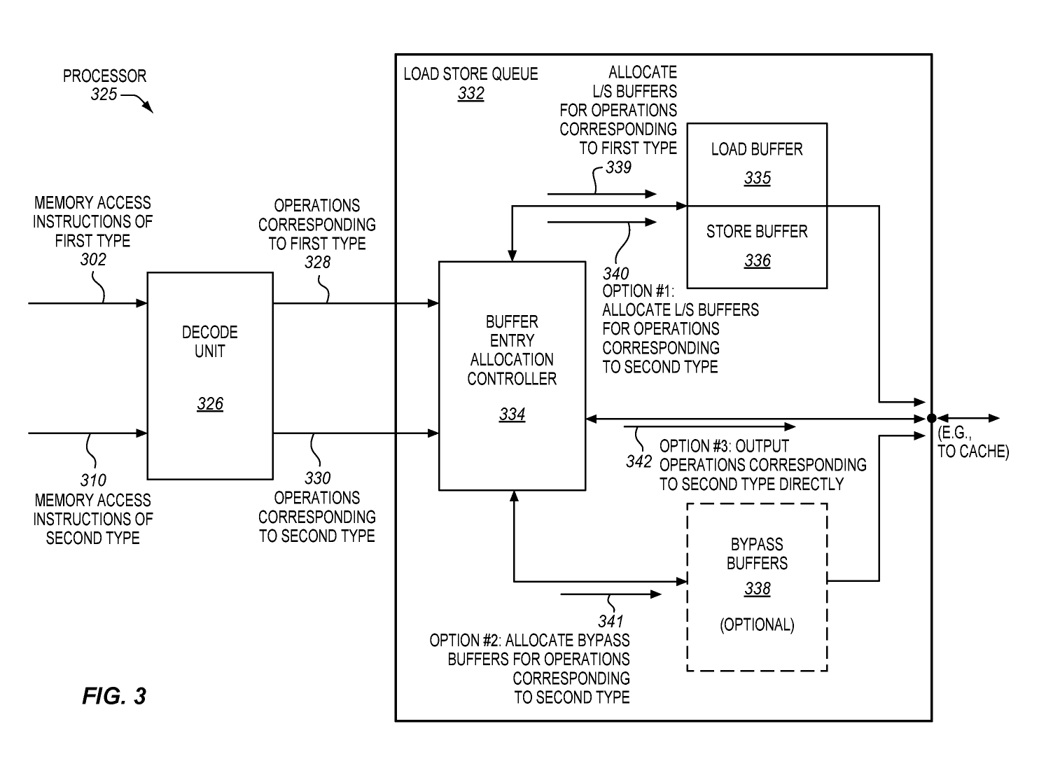

FIG. 3 is a block diagram of an embodiment of a processor 325 that is operative to perform memory access instructions of a first type 302 and memory access instructions of a second, different type 310, and to allocate entries in a load buffer 335 and a store buffer 336 based at least in part on whether memory access operations correspond to the memory access instructions of the first type 302 or the second type 310. In some embodiments, the processor may be operative to perform the method 220 of FIG. 2. The components, features, and specific optional details described herein for the processor 325, also optionally apply to the method 220. Alternatively, the method 220 may optionally be performed by and/or within a similar or different processor, integrated circuit, or other apparatus. Moreover, the processor 325 may perform methods the same as, similar to, or different than the method 220.

In some embodiments, the processor 325 may be a general-purpose processor (e.g., a general-purpose microprocessor or central processing unit (CPU) of the type used in desktop, laptop, or other computers). Alternatively, the processor may be a special-purpose processor. Examples of suitable special-purpose processors include, but are not limited to, network processors, communications processors, cryptographic processors, graphics processors, co-processors, embedded processors, digital signal processors (DSPs), and controllers (e.g., microcontrollers). The processor may have any of various complex instruction set computing (CISC) architectures, reduced instruction set computing (RISC) architectures, very long instruction word (VLIW) architectures, hybrid architectures, other types of architectures, or have a combination of different architectures (e.g., different cores may have different architectures). In various embodiments, the processor may represent at least a portion of an integrated circuit (e.g., a system on a chip (SoC)), may be included on a die or semiconductor substrate, may include semiconductor material, may include transistors, etc.

During operation, the processor 325 may receive the memory access instructions of the first type 302 and the memory access instructions of the second, different type 310. For example, these instructions may be received from memory over a bus or other interconnect. The instructions may represent macroinstructions, machine code instructions, or other instructions or control signals of an instruction set of the processor. In some embodiments, the instructions of the first type 302 may optionally include any of the instructions 102 of FIG. 1, and the instructions of the second type 310 may optionally include any of the instructions 110, although the scope of the invention is not so limited. For example, in some embodiments, the instructions of the first type 302 may include at least one load instruction and one store instruction, whereas the instructions of the second type 310 may include at least one instruction which is one of a prefetch instruction, a cache line flush instruction, a cache line write back instruction, an instruction to move a cache line between caches, and a persistent commit instruction.

Referring again to FIG. 3, the processor 325 includes a decoder or decode unit 326. The decode unit may receive and decode the instructions of the first and second types 302, 310. The decode unit may output one or more memory access operations for each of the instructions of the first and second types. For example, as shown, the decode unit may output memory access operations 328 corresponding to the instructions of the first type 302, and may output memory access operations 330 corresponding to the instructions of the second type 310. These operations may present relatively lower-level instructions or control signals (e.g., one or more microinstructions, micro-operations, decoded instructions or control signals, etc.), which reflect, represent, and/or are derived from the relatively higher-level instructions of the first and second types. In some embodiments, the decode unit may include one or more input structures (e.g., port(s), interconnect(s), an interface) to receive the instructions of the first and second types, an instruction recognition and decode logic coupled therewith to recognize and decode the various instructions of the first and second types, and one or more output structures (e.g., port(s), interconnect(s), an interface) coupled therewith to output the corresponding operations. The decode unit may be implemented using various different mechanisms including, but not limited to, microcode read only memories (ROMs), look-up tables, hardware implementations, programmable logic arrays (PLAs), and other mechanisms suitable to implement decode units.

In some embodiments, instead of the instructions of the first and second types being provided directly to the decode unit, an instruction emulator, translator, morpher, interpreter, or other instruction conversion module may optionally be used. Various types of instruction conversion modules may be implemented in software, hardware, firmware, or a combination thereof. In some embodiments, the instruction conversion module may be located outside the processor, such as, for example, on a separate die and/or in a memory (e.g., as a static, dynamic, or runtime emulation module). By way of example, the instruction conversion module may receive the instructions of the first and second types, which may be of a first instruction set, and may emulate, translate, morph, interpret, or otherwise convert the instructions of the first and second types into one or more corresponding intermediate instructions or control signals, which may be of a second different instruction set. The one or more intermediate instructions or control signals of the second instruction set may be provided to a decode unit (e.g., decode unit 326), which may decode them into corresponding operations (e.g., one or more lower-level instructions or control signals executable by execution units or other native hardware of the processor).

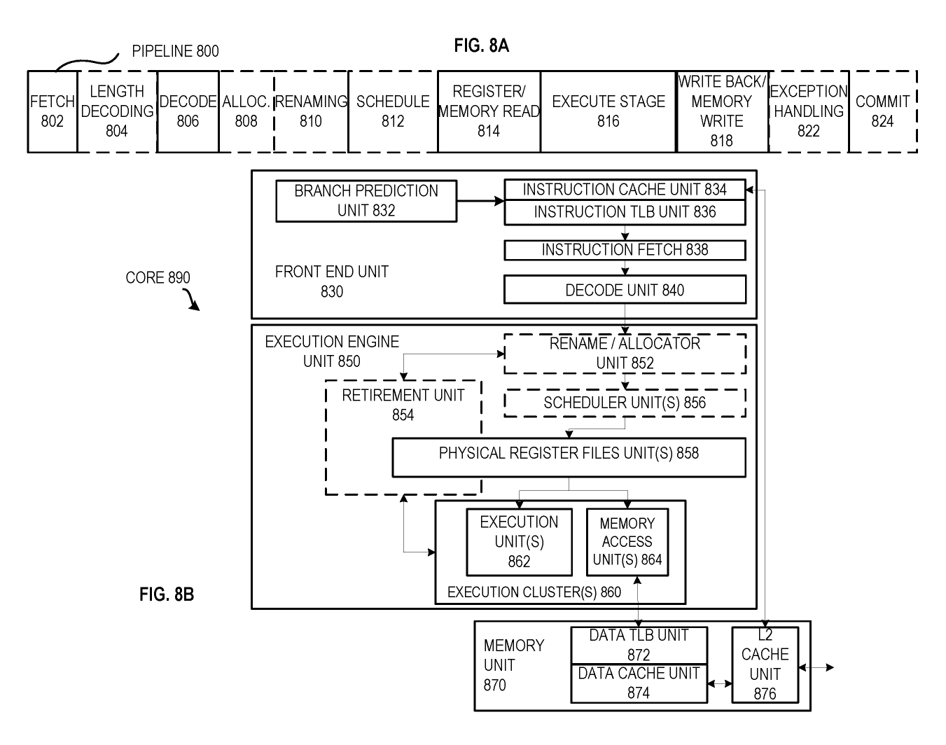

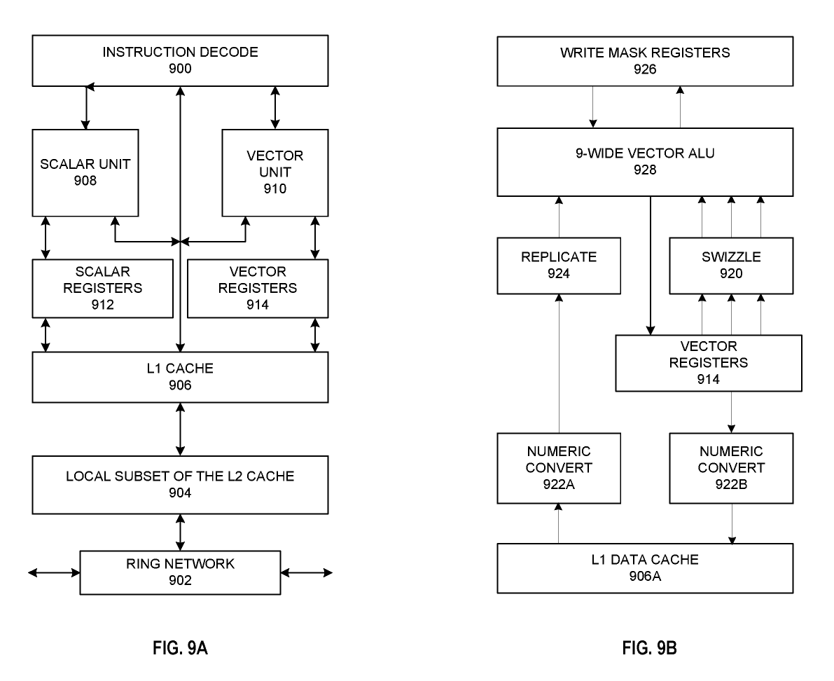

Referring again to FIG. 3, the operations 328 corresponding to the instructions of the first type 302, and the operations 330 corresponding to the instructions of the second type 310, may progress through a pipeline of the processor. For example, in the case of an out-of-order processor (which is not required), the pipeline may often include a rename/allocator unit, one or more scheduler units, a reorder buffer, a reservation station, a retirement unit, and the like. Approaches similar to those disclosed herein may also be used to allocate microarchitectural resources for various of these other microarchitectural structures (e.g., other queues or buffers in the pipeline before or after the load store queue). In the case of memory access instructions, the pipeline may also often include a load store queue 332, one or more memory access units, a memory unit, one or more translation lookaside buffers (TLBs), one or more caches, and the like. In order to better illustrate the operation of an embodiment of the load store queue 332, and to avoid complicating the illustration, only the load store queue is shown in the illustration. However, it is to be appreciated that other pipeline components may be coupled between the decode unit and the load store queue and still other pipeline components may be coupled at the output of the load store queue. For example, various different embodiments may include various different combinations and configurations of the components shown and described for any of FIGS. 8B, 9A/B, 10. All such processor components may be coupled together to allow them to operate.

The load store queue 332 is coupled with the decode unit 326 to receive the operations 328 and the operations 330. The load store queue includes a load buffer 335 that during operation may be operative to have a plurality of load buffer entries. The load store queue also includes a store buffer 336 that during operation may be operative to have a plurality of store buffer entries. During operation, the entries in the load and store buffers may be allocated to, and may be used to buffer, in-flight memory access operations. The load store queue may also be operative to maintain the in-flight memory access operations generally in program order, at least where needed to maintain consistency, and may be operative to support checks or searches for memory dependencies in order to honor the memory consistency/dependency model. In some embodiments, the load and store buffers may optionally be implemented as content addressable memory (CAM) structures. Alternatively, other approaches known in the arts may optionally be used to implement the load and store buffers.

The load and store buffers 325, 326 typically have only a limited number of load buffer entries and store buffer entries, respectively. At certain times during operation there may be relatively high levels of cache and/or memory accesses. Especially at such times, the load store queue may tend to experience pressure, in which there may not be enough load and/or store buffer entries to service, or most effectively service, all of the in-flight memory access operations. At such times, the load store queue may tend to limit performance. For example, there may not be as many entries as desirable to allocate to the operations 328. The embodiments disclosed herein may advantageously help to relieve or at least reduce some of the pressure on the load store queue and/or may help to achieve more memory access throughput with a given number of buffer entries.

Referring again to FIG. 3, the load store queue includes a buffer entry allocation controller 334. The buffer entry allocation controller is coupled with the load buffer 335, and is coupled with the store buffer 336. The buffer entry allocation controller may serve as a sequencer to make rapid decisions for operations on the fly, allocate entries for them, check for dependencies, and maintain a proper sequence of the operations. The buffer entry allocation controller may be operative to allocate entries in the load and store buffers for memory access operations. In some embodiments, the buffer entry allocation controller may be operative to allocate the load and store buffer entries, based at least in part, on whether received memory access operations (e.g., a mixture of the operations 328 and 330) correspond to memory access instructions of the first type 302 or the second type 310. In some embodiments, the buffer entry allocation controller may be operative to allocate the load and store buffer entries differently for the memory access operations 330 corresponding to the instructions of the second type 310, than for memory access operations 328 corresponding to the instructions of the first type 302. With regard to load and store buffer entry allocation, the memory access operations corresponding to the instructions of the first and second types may be handled, treated, or processed differently. The buffer entry allocation controller may be implemented in hardware (e.g., circuitry, integrated circuitry, transistors, other circuit elements, etc.), firmware (e.g., read only memory (ROM), erasable programmable ROM (EPROM), flash memory, or other persistent or non-volatile memory storing microcode, microinstructions, or other lower-level instructions or control signals), software, or a combination thereof (e.g., at least some hardware potentially/optionally combined with some firmware).

Referring again to FIG. 3, as shown at 339, the buffer entry allocation controller 334 and/or the load store queue 332 may be operative to unconditionally allocate one or more entries in the load and store buffers 335, 336 for each of the operations 328 corresponding to the instructions of the first type 302. Conventionally, one or more entries in the load and store buffers 335, 336 would also be allocated for each of the operations 330 corresponding to the instructions of the second type 310. However, in some embodiments, as shown at option#1 340, option#2 341, and option#3 342, the buffer entry allocation controller 334 and/or the load store queue 332, may be operative to have multiple different options for handling or processing the operations 330 corresponding to the instructions of the second type 310. In some embodiments, these multiple different options may include either allocating one or more entries in the load and store buffers, or not allocating any entries in the load and store buffers. In some embodiments, one or more entries in the load and store buffers may either be conditionally allocated, or conditionally not allocated, for each of the memory access operations 330, based at least in part on making one or more determinations to see if one or more conditions are met or satisfied.

In some embodiments, as shown at option#1 340, the buffer entry allocation controller 334 and/or the load store queue 332 may be operative to conditionally allocate one or more entries in the load and store buffers 335, 336 to the memory access operations 330 based on one or more conditions being determined to be satisfied. For example, whether or not to allocate the one or more entries in the load and store buffers for the operations 330 may be based at least in part on a current level of fullness, allocation, or utilization of the load and store buffers (e.g., whether the current utilization of the load and/or store buffers is under or over a threshold).

In other embodiments, as shown at option#2, the buffer entry allocation controller 334 and/or the load store queue 332 may optionally be operative to allocate or conditionally allocate one or more entries in an optional bypass buffer 338 to the operations 330. The bypass buffer is optional not required. When included the bypass buffer 338 may be coupled with the buffer entry allocation controller. During operation the bypass buffer may be operative to have multiple entries that may be allocated to, and may be used to buffer, the memory access operations 330 corresponding to the instructions of the second type 310, but not the memory access operations 328 corresponding to the instructions of the first type 302. The bypass buffer may represent a new type of buffer to buffer and track the memory access operations 330 so that they don't need to be stored in the load and store buffer entries. In some embodiments, the bypass buffer may also be operative to support checks or searches for memory dependencies in order to honor the memory consistency/dependency model. In some embodiments, the bypass buffer may be operative to maintain the in-flight memory access operations 330 generally in program order, at least where needed to maintain consistency. In some embodiments, the bypass buffer may be relatively more weakly memory ordered (e.g., have or follow a weaker memory order model) than the load buffer and the store buffer. In some embodiments, the bypass buffer may have more relaxed memory dependency checking than the load buffer and the store buffer. In some embodiments, the bypass buffer may optionally be smaller (e.g., have less entries) and have correspondingly faster access times (e.g., one or more clock cycles faster access latency) than the load and store buffers. In some embodiments, certain types of the operations corresponding to the instructions of the second type may optionally be discarded and/or ignored, if desired. For example, this may be useful if the bypass buffer is full and cannot accommodate more operations. Generally, operations corresponding to the prefetch instruction, instructions to move a cache line between caches, and other such instructions which are not strictly required for correctness, may optionally be discarded and/or ignored, if desired. For other types of operations corresponding to the instructions of the second type, such as, for example, operations corresponding to the cache line flush instructions, the persistent commit instructions, and others, it may not be possible to simply drop or discard them, or at least certain additional checking or conditions should be evaluated to ensure that ensure that incorrect results would not be achieved if they were discarded or ignored.

As shown, in some embodiments, the bypass buffer may optionally be implemented as a separate or discrete buffer or other structure from the load and store buffers. By way of example, the bypass buffer be implemented as content addressable memory (CAM) structure, although the scope of the invention is not so limited. Alternatively, in other embodiments, bypass buffer may optionally be implemented within the load and store buffers. For example, the entries in the load and store buffers may have one or more bits that are capable of being set or configured to mark or designate the entries as being normal load and store buffer entries, or bypass buffer entries. The bypass buffer entries may be handled differently than the normal load and store buffer entries (e.g., selectively allocated for the operations 330 but not the operations 328, being relatively more weakly memory ordered, having more relaxed memory dependency checking, etc.).

Referring again to FIG. 3, in still other embodiments, as shown at option#3, the buffer entry allocation controller 334 and/or the load store queue 332 may optionally output the memory access operations 330 from the load store queue 332 directly, without allocating any entries in the load and store buffers 335, 336, and without allocating any entries in the optional bypass buffer 338. For example, the memory access operations 330 may be output directly from the load store queue toward a cache port (e.g., an L1 data cache port) without being buffered in the load store queue.

In some embodiments, the load store queue 332 and/or the buffer entry allocation controller 334 may be operative to intelligently and/or adaptively determine what to do with the memory access operations 330 based on evaluation of one or more, or any combination, of the following factors: (1) the current level of fullness, occupancy, allocation, or utilization of the load and store buffers (e.g., whether a number or proportion of the currently utilized entries is above or below a threshold); (2) whether the memory access operations 330 have any dependencies with any memory access operations for which load and/or store buffer entries have already been allocated; (3) whether the memory access operations 330 can be output directly without being allocated to a buffer entry (e.g., if there are no conflicting data dependencies); (4) whether there are resources available to output the memory access operations 330 directly; (5) whether or not the bypass buffer 338 exists to buffer the memory access operations 330. These are just a few examples. Other embodiments may use any one or more of these conditions optionally together with other conditions, or different conditions entirely.

Accordingly, in some embodiments, the buffer entry allocation controller 334 and/or the load store queue 332 and/or the processor 325 may be operative, at least at certain times (e.g., when the load and store buffers are experiencing pressure) and/or at least under certain conditions (e.g., when there are no data dependencies and when resources are available (or will soon be available or can be freed) to output the operations directly) not to allocate any entries in the load and store buffers for an operation 330 corresponding to an instruction of the second type 310. This may offer various possible advantages depending upon the particular implementation. For one thing, this may allow entries in the load and store buffers that are not used for the operations 330 to instead be used for the operations 328. This may help to allow the total number of outstanding load or store misses to be increased and/or may help to increase the core or other logical processors effective bandwidth to memory. For another thing, this may help to reduce the overhead of implementing the memory access instructions of the second type 310 (e.g., in terms of load and/or store buffer consumption), which in turn may help to improve performance, especially for applications that are cache-sensitive or memory-bandwidth sensitive.

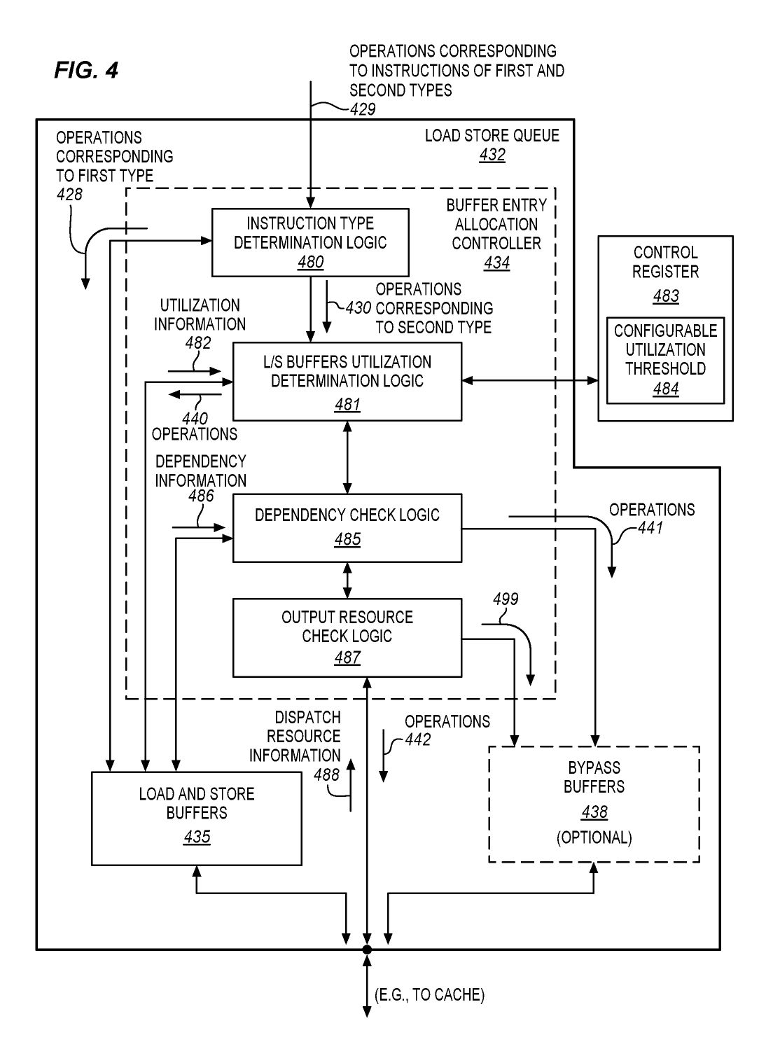

FIG. 4 is a block diagram illustrating a detailed example embodiment of a load store queue 432. In some embodiments, the load store queue 432 may be used as the load store queue 332 of FIG. 3. Alternatively, the processor 325 may have a similar or different load store queue.

The load store queue 432 includes a detailed example embodiment of a buffer entry allocation controller 434, load and store buffers 435, and in some embodiments may optionally include a bypass buffer 438. The load and store buffers, and the bypass buffer, may have characteristics similar to, or the same as, those previously described.

The buffer entry allocation controller 434 includes instruction type determination logic 480, load and store (L/S) buffer utilization determination logic 481, dependency check logic 485, and output resource check logic 487. These components are coupled together as shown by the arrows in the diagram. These units, components, or other logic may be implemented in hardware (e.g., circuitry, integrated circuitry, transistors, other circuit elements, etc.), firmware (e.g., read only memory (ROM), erasable programmable ROM (EPROM), flash memory, or other persistent or non-volatile memory storing microcode, microinstructions, or other lower-level instructions or control signals), software, or a combination thereof (e.g., at least some hardware potentially/optionally combined with some firmware).

During operation, the load store queue 432 is operative to receive operations 429 corresponding to memory access instructions of first and second types. In some embodiments, the memory access instructions of the first type may include any one or more of the instructions 102 of FIG. 1, and the memory access instructions of the second type may include any one or more of the instructions 110 of FIG. 1, although the scope of the invention is not so limited. The operations 429 may be provided to the instruction type determination logic 480. In some embodiments, the instruction type determination logic may be operative to determine whether each of the operations corresponds to a memory access instruction of the first type or the second type. As shown, operations 428 that correspond to memory access instructions of the first type may be provided to the load and store buffers 435, and one or more entries in the load and store buffers may be allocated for each of these operations. In contrast, operations 430 that correspond to memory access instructions of the second type may be provided to the load and store (L/S) buffer utilization determination logic 481.

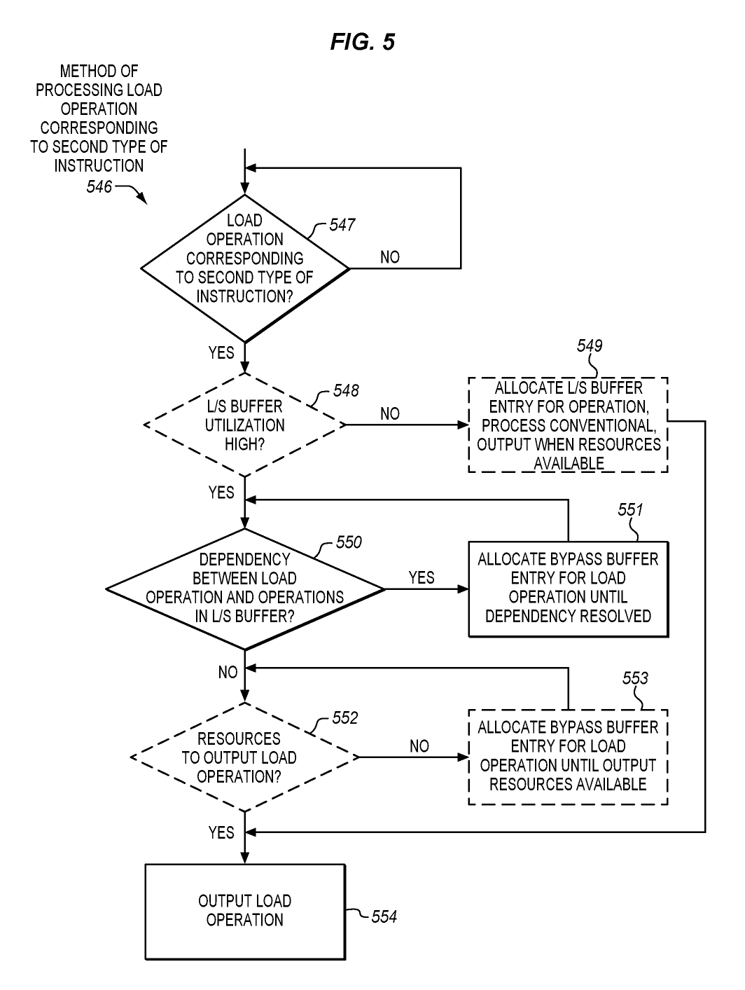

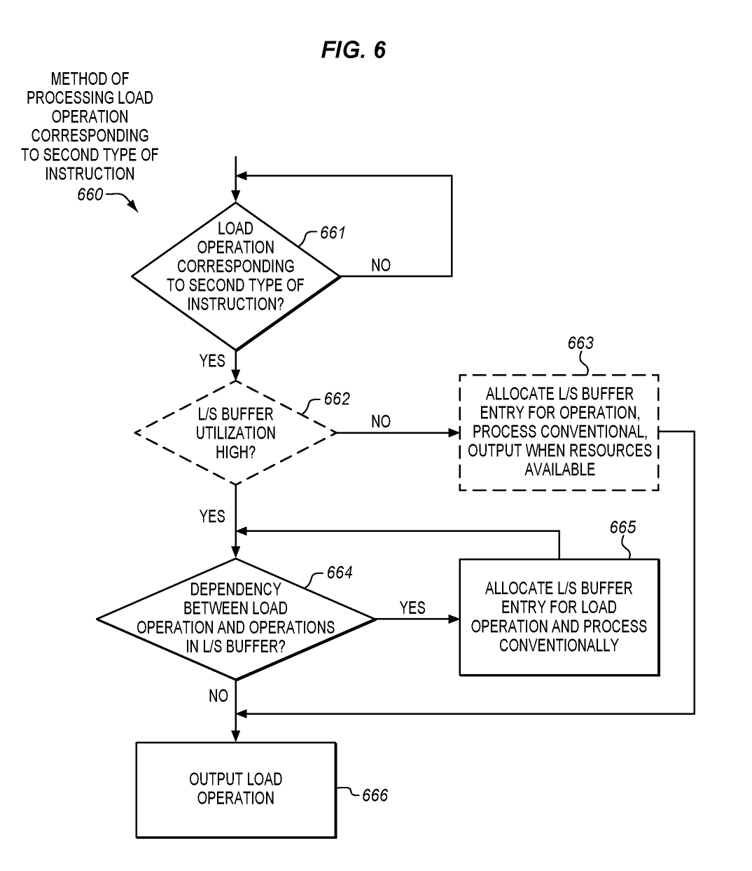

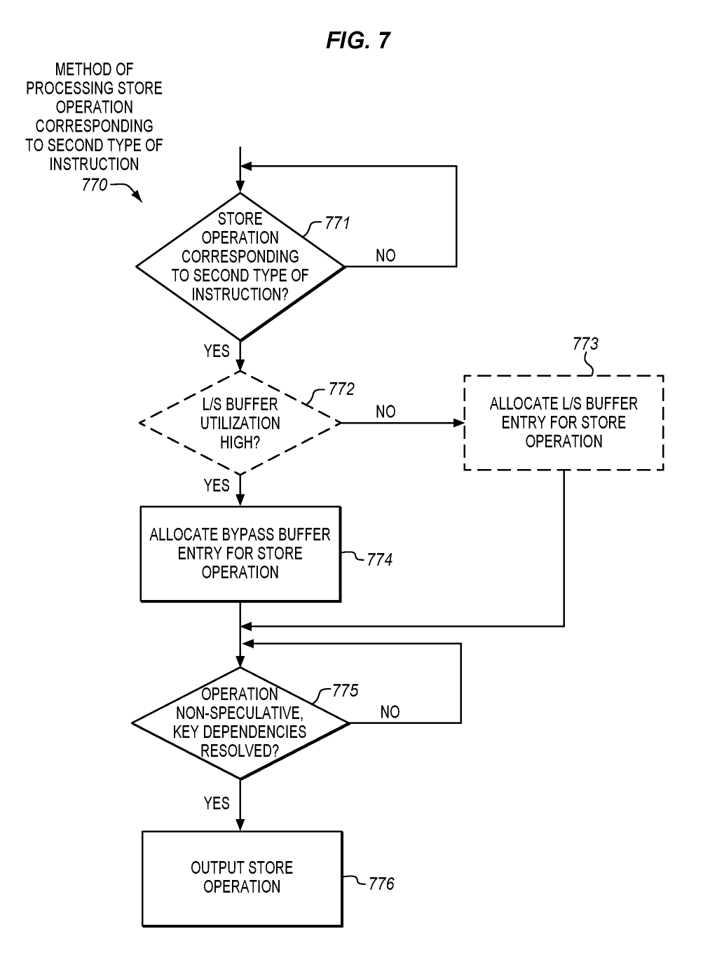

In some embodiments, the operations 430 may be processed differently by the load store queue 432 and/or the buffer entry allocation controller 434, depending upon whether they are load or store operations. By way of example, in some embodiments, load operations may be processed according to the method of either FIG. 5 (e.g., if the load store queue includes the optional bypass buffer 438) or FIG. 6 (e.g., if the load store queue does not include the bypass buffer). Store operations, in some embodiments, may be processed according to the method of FIG. 7. Alternatively, similar or different methods may be used to process the load and store operations.

The load and store buffer utilization determination logic 481, in some embodiments, may be operative to evaluate or determine a current level of fullness, allocation, or utilization of the load and store buffers 435 (e.g., whether the current level of utilization of the load and/or store buffers is under or over a threshold). The load and store buffer utilization determination logic may receive utilization information 482 from, or at least associated with, the load and store buffers. By way of example, the utilization information may be provided by a signal over direct wiring to the load and store buffers, or may be provided by a performance monitoring unit, or the like. In some embodiments, if the current utilization is sufficiently low for the particular implementation (e.g., the current level of utilization of the load and/or store buffers is under a threshold), the operations 440 corresponding to the instructions of the second type may be provided to the load and store buffers 435, and each of the operations may be allocated to one or more entries in the load and store buffers.

Representatively, such a current low utilization may indicate that the load and store buffers are not currently experiencing pressure and/or that there are currently a sufficient number of entries to effectively service the operations 428 corresponding to the memory access instructions of the first type. In such cases, there may be no need not to allocate entries in the load and store buffers and/or there may not be as much benefit to departing from conventional processing of the operations 440. In some embodiments, under such situations, the optional bypass buffer, if optionally included in a particular implementation, and if empty, may optionally be powered off, or at least placed into a reduced power state, in order to help conserve power, although this is not required. Conversely, in some embodiments, if the current utilization is not sufficiently low for the particular implementation (e.g., the current level of utilization of the load and/or store buffers is above a threshold), the operations 440 corresponding to the instructions of the second type may not be allocated to the entries in the load and store buffers 435.

As shown, in some embodiments, a configurable utilization threshold 484 may optionally be used by the load store buffer utilization determination logic 481. As shown, the configurable utilization threshold may optionally be included in a register 483 (e.g., a control and/or configuration register). Alternatively, other storage locations may optionally be used. In some embodiments, the configurable utilization threshold may optionally be tuned or otherwise configured to achieve objectives desired for a particular implementation. For example, performance and power monitoring may optionally be used, and performance tuning may optionally be used to change the threshold to determine a value for the threshold that provides a desired balance of performance and power efficiency for a particular implementation.

Referring again to FIG. 4, the buffer entry allocation controller 434 also includes the dependency check logic 485. For load operations, in cases where the buffer entry allocation controller does not determine to allocate the load operations to the load and store buffers 435, the dependency check logic may be operative to determine whether or not the load operations have any dependencies with load and/or store operations already allocated to entries in the load and store buffers. For example, data dependencies may exist if the operations have the same physical memory address. If such a dependency does exist, then the load operation should be ordered with any such other load and/or store operations already allocated to entries in the load and store buffers for which the dependencies exist. In some embodiments, if such a dependency does exist, the load operation 441 may be allocated to one or more entries in the optional bypass buffer 438, if it exists. Alternatively, if the optional bypass buffer 438 does not exist, the load operation may instead be allocated to one or more entries in the load and store buffers when such a dependency exists (see e.g., the discussion of FIG. 5 further below). The load operation may remain in the bypass buffer (or in the load and store buffers) until the dependency has been resolved.

Referring again to FIG. 4, the buffer entry allocation controller 434 also includes the output resource check logic 487. The output resource check logic may be operative to check or determine whether there are currently resources available to output load and/or store operations. For example, this may include checking the availability of cache ports and/or other resources needed to output data from the load store queue. In some embodiments, in cases where there are no dependencies with load and/or store operations already allocated to entries in the load and store buffers, and in cases where the output resource check logic determines that there are currently resources available, the operations 442 may be output directly. For example, the operations 442 may be provided to a cache port of a cache directly bypassing the load and store buffers and bypassing the bypass buffer. The operations 442 may be output without any entries having been allocated in the load and store buffers and/or the optional bypass buffer and/or substantially without any buffering or queuing within the load store queue.

Alternatively, in cases where there currently are not resources available, the operations 499 may be provided to the optional bypass buffer (if one exists), and one or more entries in the bypass buffer may be allocated to these operations. Or, in cases where the bypass buffer is optionally not included in the design, the operations may instead be allocated to entries in the load and store buffers. If allocated to an entry in the bypass buffer entry, or in the load and store buffers, in cases where there are no dependencies and/or the dependencies have been resolved, the operations may be output when resources become available. In some embodiment, especially when the operations corresponding to the instructions of the second type have been allocated to entries in the load and store buffers, they may be output eagerly/quickly and/or with priority (e.g., as soon as resources are available and there are no data dependencies) in order to help free the entries in the load and store buffers for other operations (e.g., the operations 428). Similarly, the operations 499 may be output from the bypass buffer 438 opportunistically when there are no dependencies and/or the dependencies have been resolved, and when resources available. In some embodiments, outputting from the bypass buffer may optionally have a lower priority or emphasis than outputting from the load and store buffers, in order to help free entries in the load and store buffers eagerly/quickly, although this is not required.

FIG. 5 is a block flow diagram of an embodiment of a method 546 of processing load operations corresponding memory access instructions of a second type when a bypass buffer is available. At block 547 the method may deter mine whether a received load operation (e.g., one received at a load store queue) is one that corresponds to one of a set of memory access instructions of a second type. Examples of load operations that correspond to memory access instructions of a second type include, but are not limited to, those of the prefetch instruction(s) 111. If the load operation does not correspond to the memory access instructions of the second type (i.e., “no” is the determination at block 547), the method may revisit block 547 and await such an operation. Alternatively, if the load operation does correspond to the memory access instructions of the second type (i.e., “yes” is the determination at block 547), the method may advance to block 548.

At block 548, an optional determination may be made whether or not the current load and store buffer utilization is sufficiently high for a particular implementation. This may be performed as previously described elsewhere herein (e.g., as described in conjunction with the load store buffer utilization determination logic 481). This level of utilization may also optionally be configurable or tunable. If the load and store buffer utilization is not sufficiently high (i.e., “no” is the determination at block 548), the method may advance to block 549. At block 549, one or more entries in the load and store buffers may be allocated for the load operation, the load operation may optionally be processed substantially conventionally, and the load operation may be output when resources are available. The method may then advance to block 554. Alternatively, if the load and store buffer utilization is sufficiently high (i.e., “yes” is the determination at block 548), the method may advance to block 550.

At block 550, a determination may be made whether or not there is a dependency between the load operation and load and/or store operations already allocated to entries in the load and store buffer. If there is a dependency (i.e., “yes” is the determination at block 550), the method may advance to block 551. At block 551, one or more entries in a bypass buffer may be allocated for the load operation, and the method may revisit block 550. The load operation may remain buffered or stored in the entry of the bypass buffer until the dependency has been resolved and/or no longer exists. Alternatively, if there is no dependency (i.e., “no” is the determination at block 550), the method may advance to block 552.

At block 552, an optional determination may be made whether or not there currently are resources to output the load operation. If there are not currently resources to output the load operation (i.e., “no” is the determination at block 552), the method may advance to block 553. At block 553, one or more entries in the bypass buffer may be allocated for the load operation, and the method may revisit block 552. The load operation may remain buffered or stored in the entry of the bypass buffer until there are resources to output the load operation. Alternatively, if there are resources currently available to output the load operation (i.e., “yes” is the determination at block 552), the method may advance to block 554. At block 554, the load operation may be output from the load store queue.

FIG. 6 is a block flow diagram of an embodiment of a method 660 of processing load operations corresponding memory access instructions of a second type when a bypass buffer is not available (e.g., is not implemented in the design of a load store queue, or is disabled). At block 661 the method may determine whether a received load operation (e.g., received at a load store queue) is one that corresponds to one of a set of memory access instructions of a second type. If the load operation does not correspond to the memory access instructions of the second type (i.e., “no” is the determination at block 547), the method may revisit block 661 and await such an operation. Alternatively, if the load operation does correspond to the memory access instructions of the second type (i.e., “yes” is the determination at block 661), the method may advance to block 662.

At block 662, an optional determination may be made whether or not the load and store buffer utilization is sufficiently high for a particular implementation. This may be performed as previously described elsewhere herein (e.g., as described in conjunction with the load store buffer utilization determination logic 481). This level may also be configurable and/or tunable. If the load and store buffer utilization is not sufficiently high (i.e., “no” is the determination at block 662), the method may advance to block 663. At block 663, one or more entries in the load and store buffers may be allocated for the load operation, the load operation may optionally be processed substantially conventionally, and the load operation may be output when resources are available. The method may then advance to block 666. Alternatively, if the load and store buffer utilization is sufficiently high (i.e., “yes” is the determination at block 662), the method may advance to block 664.

At block 664, a determination may be made whether or not there is a dependency between the load operation and load and/or store operations already allocated to entries in the load and store buffer. If there is a dependency (i.e., “yes” is the determination at block 664), the method may advance to block 665. At block 665, one or more entries in the load and store buffers may be allocated for the load operation, and the method may revisit block 664. Notice that in this case, as compared to the method of FIG. 5, since the bypass buffer is not available, the load operation is instead allocated to one or more entries in the load and store buffers, when a dependency exists. However, in some embodiments it may optionally be quickly reclaimed as soon as the dependency is resolved and/or no longer exists. The load operation may remain buffered in the load and store buffers until the dependency has been resolved and/or no longer exists.

Alternatively, if there is no dependency (i.e., “no” is the determination at block 664), the method may advance to block 666. In this case, even though there is not a bypass buffer to relieve pressure on the load and store buffers, load operations may be output eagerly/quickly without needing to allocate an entry in the load and store buffers, at least in cases where there are no dependencies that need to be respected. In some embodiments, the core or other logical processor may also disregard any “completion” messages returned from the uncore for the store operation to trigger deallocation of entries in the load and store buffers, since no load and store buffer entries were allocated.

At block 666, the load operation may be output. In some embodiments, this may include freeing resources to output the load operation eagerly and/or quickly and/or with priority. In some embodiments (e.g., if the load and store buffer utilization was high and there were no dependencies), the load operation may have been output without an entry having been allocated. In another embodiments, the method may optionally incorporate operations similar to those of block 552 to check whether or not resources are available, and allocate one or more entries in the load and store buffers when resources are not available.

FIG. 7 is a block flow diagram of an embodiment of a method 770 of processing store operations corresponding memory access instructions of a second type. At block 771 the method may determine whether a received store operation is one that corresponds to a set of one or more memory access instructions of a second type. Examples of store operations for instructions of the second type include, but are not limited to, those of the cache line flush instruction 112, the cache line write back instruction 113, and the instructions to move data between caches 114. If the store operation does not correspond to the memory access instructions of the second type (i.e., “no” is the determination at block 771), the method may revisit block 771 and await such an operation. Alternatively, if the store operation does correspond to the memory access instructions of the second type (i.e., “yes” is the determination at block 771), the method may advance to block 772.

At block 772, an optional determination may be made whether or not the load and store buffer utilization is sufficiently high for a particular implementation. This may be performed as previously described elsewhere herein (e.g., as described in conjunction with the load store buffer utilization determination logic 481). The level may optionally be configurable and/or tunable. If the load and store buffer utilization is not sufficiently high (i.e., “no” is the determination at block 772), the method may advance to block 773. At block 773, one or more entries in the load and store buffers may be allocated for the store operation. The method may then advance to block 775. Alternatively, if the load and store buffer utilization is sufficiently high (i.e., “yes” is the determination at block 772), the method may advance to block 774. At block 774, one or more entries in a bypass buffer may be allocated for the store operation. The method may then advance to block 775.

At block 775, a determination may be made whether or not the store operation is non-speculative and key dependencies have been resolved. This may determine in part if the operation is ready to be issued. Before issuing the store operation to downstream processing, it may be insured that a branch has not been miss-predicated and that key dependencies have been resolved. If the store operation is speculative (i.e., “no” is the determination at block 775), the method may revisit block 775 until the store operation is no longer speculative. The store operation generally shouldn't be output (e.g., sent to a cache) until speculation has been resolved (e.g., the operations are ready to be committed). Alternatively, if the store operation is non-speculative (i.e., “yes” is the determination at block 775), the method may advance to block 776.

At block 776, the store operation may be output. In some embodiments, this may include freeing resources to output the store operation immediately. In another embodiments, the method may optionally incorporate operations similar to those of block 552 to check whether or not resources are available, and allocate one or more entries in the bypass buffer when resources are not available, until they become available.

In some embodiments, the methods of FIGS. 5-7 may be performed by an integrated circuit processor, load store queue, or buffer entry allocation controller. In some embodiments, the methods of FIGS. 5-7 may be performed by and/or with the processor 325, load store queue 332, or buffer entry allocation controller 334 of FIG. 3 and/or may be performed by and/or with the load store queue 432, or buffer entry allocation controller 434 of FIG. 4. The components, features, and specific optional details described herein for FIGS. 3-4 also optionally apply to the methods of FIGS. 5-7. Alternatively, the methods of FIGS. 5-7 may optionally be performed by and/or within a similar or different apparatus. Moreover, the apparatus of FIGS. 3-4 may optionally perform similar or different methods than those of FIGS. 5-7.

In the discussion above, to further illustrate certain concepts, allocation of entries in load and store buffers have been emphasized. However, analogous approaches may instead be used to allocate other microarchitectural resources (e.g., entries in other microarchitectural queues or buffers). For example, an analogous approach may optionally be used for the queue structures between the L1 and L2 caches. Accordingly, broadly, a processor may perform memory access instruction type dependent allocation of microarchitectural resources (e.g., entries in various queues or buffers within the memory subsystem of the processor).

Exemplary Core Architectures, Processors, and Computer Architectures

Processor cores may be implemented in different ways, for different purposes, and in different processors. For instance, implementations of such cores may include: 1) a general purpose in-order core intended for general-purpose computing; 2) a high performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput). Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip that may include on the same die the described CPU (sometimes referred to as the application core(s) or application processor(s)), the above described coprocessor, and additional functionality. Exemplary core architectures are described next, followed by descriptions of exemplary processors and computer architectures.

Exemplary Core Architectures

In-Order and Out-of-Order Core Block Diagram

FIG. 8A is a block diagram illustrating both an exemplary in-order pipeline and an exemplary register renaming, out-of-order issue/execution pipeline according to embodiments of the invention. FIG. 8B is a block diagram illustrating both an exemplary embodiment of an in-order architecture core and an exemplary register renaming, out-of-order issue/execution architecture core to be included in a processor according to embodiments of the invention. The solid lined boxes in FIGS. 8A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8A, a processor pipeline 800 includes a fetch stage 802, a length decode stage 804, a decode stage 806, an allocation stage 808, a renaming stage 810, a scheduling (also known as a dispatch or issue) stage 812, a register read/memory read stage 814; an execute stage 816, a write back/memory write stage 818, an exception handling stage 822, and a commit stage 824.

FIG. 8B shows processor core 890 including a front end unit 830 coupled to an execution engine unit 850, and both are coupled to a memory unit 870. The core 890 may be a reduced instruction set computing (RISC) core, a complex instruction set computing (CISC) core; a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front end unit 830 includes a branch prediction unit 832 coupled to an instruction cache unit 834, which is coupled to an instruction translation lookaside buffer (TLB) 836, which is coupled to an instruction fetch unit 838, which is coupled to a decode unit 840. The decode unit 840 (or decoder) may decode instructions, and generate as an output one or more micro-operations, micro-code entry points, microinstructions, other instructions, or other control signals, which are decoded from, or which otherwise reflect; or are derived from, the original instructions. The decode unit 840 may be implemented using various different mechanisms. Examples of suitable mechanisms include, but are not limited to, look-up tables, hardware implementations, programmable logic arrays (PLAs), microcode read only memories (ROMs), etc. In one embodiment, the core 890 includes a microcode ROM or other medium that stores microcode for certain macroinstructions (e.g., in decode unit 840 or otherwise within the front end unit 830). The decode unit 840 is coupled to a rename/allocator unit 852 in the execution engine unit 850.

The execution engine unit 850 includes the rename/allocator unit 852 coupled to a retirement unit 854 and a set of one or more scheduler unit(s) 856. The scheduler unit(s) 856 represents any number of different schedulers, including reservations stations, central instruction window, etc. The scheduler unit(s) 856 is coupled to the physical register file(s) unit(s) 858. Each of the physical register file(s) units 858 represents one or more physical register files; different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) unit 858 comprises a vector registers unit, a write mask registers unit, and a scalar registers unit. These register units may provide architectural vector registers, vector mask registers, and general purpose registers. The physical register file(s) unit(s) 858 is overlapped by the retirement unit 854 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement unit 854 and the physical register file(s) unit(s) 858 are coupled to the execution cluster(s) 860. The execution cluster(s) 860 includes a set of one or more execution units 862 and a set of one or more memory access units 864. The execution units 862 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 856, physical register file(s) unit(s) 858, and execution cluster(s) 860 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 864). It should also be understood that where separate pipelines are used, one or more of these pipelines may be out-of-order issue/execution and the rest in-order.

The set of memory access units 864 is coupled to the memory unit 870, which includes a data TLB unit 872 coupled to a data cache unit 874 coupled to a level 2 (L2) cache unit 876. In one exemplary embodiment, the memory access units 864 may include a load unit, a store address unit, and a store data unit, each of which is coupled to the data TLB unit 872 in the memory unit 870. The instruction cache unit 834 is further coupled to a level 2 (L2) cache unit 876 in the memory unit 870. The L2 cache unit 876 is coupled to one or more other levels of cache and eventually to a main memory.

By way of example, the exemplary register renaming, out-of-order issue/execution core architecture may implement the pipeline 800 as follows: 1) the instruction fetch 838 performs the fetch and length decoding stages 802 and 804; 2) the decode unit 840 performs the decode stage 806; 3) the rename/allocator unit 852 performs the allocation stage 808 and renaming stage 810; 4) the scheduler unit(s) 856 performs the schedule stage 812; 5) the physical register file(s) unit(s) 858 and the memory unit 870 perform the register read/memory read stage 814; the execution cluster 860 perform the execute stage 816; 6) the memory unit 870 and the physical register file(s) unit(s) 858 perform the write back/memory write stage 818; 7) various units may be involved in the exception handling stage 822; and 8) the retirement unit 854 and the physical register file(s) unit(s) 858 perform the commit stage 824.

The core 890 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 890 includes logic to support a packed data instruction set extension (e.g., AVX1, AVX2), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 834/874 and a shared L2 cache unit 876, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

Specific Exemplary In-Order Core Architecture

FIGS. 9A-B illustrate a block diagram of a more specific exemplary in-order core architecture, which core would be one of several logic blocks (including other cores of the same type and/or different types) in a chip. The logic blocks communicate through a high-bandwidth interconnect network (e.g., a ring network) with some fixed function logic, memory I/O interfaces, and other necessary I/O logic, depending on the application.

FIG. 9A is a block diagram of a single processor core, along with its connection to the on-die interconnect network 902 and with its local subset of the Level 2 (L2) cache 904, according to embodiments of the invention. In one embodiment, an instruction decoder 900 supports the x86 instruction set with a packed data instruction set extension. An L1 cache 906 allows low-latency accesses to cache memory into the scalar and vector units. While in one embodiment (to simplify the design), a scalar unit 908 and a vector unit 910 use separate register sets (respectively, scalar registers 1912 and vector registers 914) and data transferred between them is written to memory and then read back in from a level 1 (L1) cache 906, alternative embodiments of the invention may use a different approach (e.g., use a single register set or include a communication path that allow data to be transferred between the two register files without being written and read back).

The local subset of the L2 cache 904 is part of a global L2 cache that is divided into separate local subsets, one per processor core. Each processor core has a direct access path to its own local subset of the L2 cache 904. Data read by a processor core is stored in its L2 cache subset 904 and can be accessed quickly, in parallel with other processor cores accessing their own local L2 cache subsets. Data written by a processor core is stored in its own L2 cache subset 904 and is flushed from other subsets, if necessary. The ring network ensures coherency for shared data. The ring network is bi-directional to allow agents such as processor cores, L2 caches and other logic blocks to communicate with each other within the chip. Each ring data-path is 1012-bits wide per direction.

FIG. 9B is an expanded view of part of the processor core in FIG. 9A according to embodiments of the invention. FIG. 9B includes an L1 data cache 906A part of the L1 cache 904, as well as more detail regarding the vector unit 910 and the vector registers 914. Specifically, the vector unit 910 is a 16-wide vector processing unit (VPU) (see the 16-wide ALU 928), which executes one or more of integer, single-precision float, and double-precision float instructions. The VPU supports swizzling the register inputs with swizzle unit 920, numeric conversion with numeric convert units 922A-B, and replication with replication unit 924 on the memory input. Write mask registers 926 allow predicating resulting vector writes.

Processor with Integrated Memory Controller and Graphics

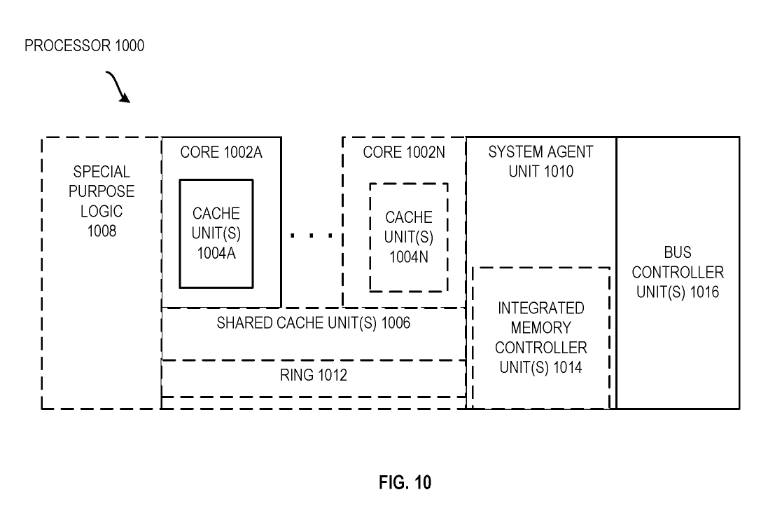

FIG. 10 is a block diagram of a processor 1000 that may have more than one core, may have an integrated memory controller, and may have integrated graphics according to embodiments of the invention. The solid lined boxes in FIG. 10 illustrate a processor 1000 with a single core 1002A, a system agent 1010, a set of one or more bus controller units 1016, while the optional addition of the dashed lined boxes illustrates an alternative processor 1000 with multiple cores 1002A-N, a set of one or more integrated memory controller unit(s) 1014 in the system agent unit 1010, and special purpose logic 1008.

Thus, different implementations of the processor 1000 may include: 1) a CPU with the special purpose logic 1008 being integrated graphics and/or scientific (throughput) logic (which may include one or more cores), and the cores 1002A-N being one or more general purpose cores (e.g., general purpose in-order cores, general purpose out-of-order cores, a combination of the two); 2) a coprocessor with the cores 1002A-N being a large number of special purpose cores intended primarily for graphics and/or scientific (throughput); and 3) a coprocessor with the cores 1002A-N being a large number of general purpose in-order cores. Thus, the processor 1000 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 1000 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache units 1006, and external memory (not shown) coupled to the set of integrated memory controller units 1014. The set of shared cache units 1006 may include one or more mid-level caches, such as level 2 (L2), level 3 (L3), level 4 (L4), or other levels of cache, a last level cache (LLC), and/or combinations thereof. While in one embodiment a ring based interconnect unit 1012 interconnects the integrated graphics logic 1008, the set of shared cache units 1006, and the system agent unit 1010/integrated memory controller unit(s) 1014, alternative embodiments may use any number of well-known techniques for interconnecting such units. In one embodiment, coherency is maintained between one or more cache units 1006 and cores 1002-A-N.

In some embodiments, one or more of the cores 1002A-N are capable of multi-threading. The system agent 1010 includes those components coordinating and operating cores 1002A-N. The system agent unit 1010 may include for example a power control unit (PCU) and a display unit. The PCU may be or include logic and components needed for regulating the power state of the cores 1002A-N and the integrated graphics logic 1008. The display unit is for driving one or more externally connected displays.

The cores 1002A-N may be homogenous or heterogeneous in terms of architecture instruction set; that is, two or more of the cores 1002A-N may be capable of execution the same instruction set, while others may be capable of executing only a subset of that instruction set or a different instruction set.

Exemplary Computer Architectures

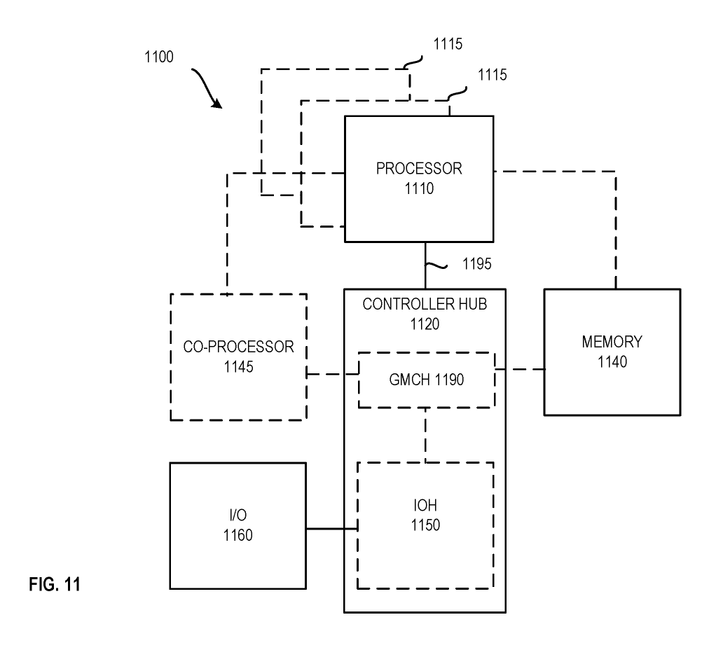

FIGS. 11-13 are block diagrams of exemplary computer architectures. Other system designs and configurations known in the arts for laptops; desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 11, shown is a block diagram of a system 1100 in accordance with one embodiment of the present invention. The system 1100 may include one or more processors 1110, 1115, which are coupled to a controller hub 1120. In one embodiment the controller hub 1120 includes a graphics memory controller hub (GMCH) 1190 and an Input/Output Hub (IOH) 1150 (which may be on separate chips); the GMCH 1190 includes memory and graphics controllers to which are coupled memory 1140 and a coprocessor 1145; the IOH 1150 is couples input/output (I/O) devices 1160 to the GMCH 1190. Alternatively, one or both of the memory and graphics controllers are integrated within the processor (as described herein), the memory 1140 and the coprocessor 1145 are coupled directly to the processor 1110, and the controller hub 1120 in a single chip with the IOH 1150.

The optional nature of additional processors 1115 is denoted in FIG. 11 with broken lines. Each processor 1110, 1115 may include one or more of the processing cores described herein and may be some version of the processor 1000.

The memory 1140 may be, for example, dynamic random access memory (DRAM), phase change memory (PCM), or a combination of the two. For at least one embodiment, the controller hub 1120 communicates with the processor(s) 1110, 1115 via a multi-drop bus, such as a frontside bus (FSB), point-to-point interface such as QuickPath Interconnect (QPI), or similar connection 1195.

In one embodiment, the coprocessor 1145 is a special-purpose processor, such as, for example, a high-throughput MIC processor, a network or communication processor, compression engine, graphics processor, GPGPU, embedded processor, or the like. In one embodiment, controller hub 1120 may include an integrated graphics accelerator.

There can be a variety of differences between the physical resources 1110, 1115 in terms of a spectrum of metrics of merit including architectural, microarchitectural, thermal, power consumption characteristics, and the like.

In one embodiment, the processor 1110 executes instructions that control data processing operations of a general type. Embedded within the instructions may be coprocessor instructions. The processor 1110 recognizes these coprocessor instructions as being of a type that should be executed by the attached coprocessor 1145. Accordingly, the processor 1110 issues these coprocessor instructions (or control signals representing coprocessor instructions) on a coprocessor bus or other interconnect, to coprocessor 1145. Coprocessor(s) 1145 accept and execute the received coprocessor instructions.

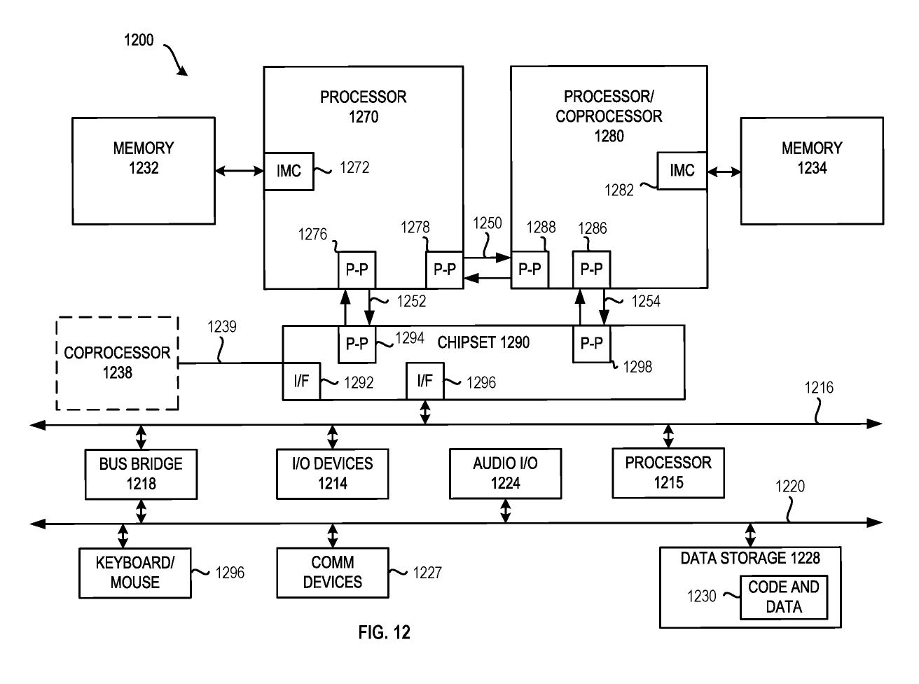

Referring now to FIG. 12, shown is a block diagram of a first more specific exemplary system 1200 in accordance with an embodiment of the present invention. As shown in FIG. 12, multiprocessor system 1200 is a point-to-point interconnect system, and includes a first processor 1270 and a second processor 1280 coupled via a point-to-point interconnect 1250. Each of processors 1270 and 1280 may be some version of the processor 1000. In one embodiment of the invention, processors 1270 and 1280 are respectively processors 1110 and 1115, while coprocessor 1238 is coprocessor 1145. In another embodiment, processors 1270 and 1280 are respectively processor 1110 coprocessor 1145.

Processors 1270 and 1280 are shown including integrated memory controller (IMC) units 1272 and 1282, respectively. Processor 1270 also includes as part of its bus controller units point-to-point (P-P) interfaces 1276 and 1278; similarly, second processor 1280 includes P-P interfaces 1286 and 1288. Processors 1270, 1280 may exchange information via a point-to-point (P-P) interface 1250 using P-P interface circuits 1278, 1288. As shown in FIG. 12, IMCs 1272 and 1282 couple the processors to respective memories, namely a memory 1232 and a memory 1234, which may be portions of main memory locally attached to the respective processors.

Processors 1270, 1280 may each exchange information with a chipset 1290 via individual P-P interfaces 1252, 1254 using point to point interface circuits 1276, 1294, 1286, and 1298. Chipset 1290 may optionally exchange information with the coprocessor 1238 via a high-performance interface 1239. In one embodiment, the coprocessor 1238 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1290 may be coupled to a first bus 1216 via an interface 1296. In one embodiment, first bus 1216 may be a Peripheral Component Interconnect (PCI) bus, or a bus such as a PCI Express bus or another third generation I/O interconnect bus, although the scope of the present invention is not so limited.

As shown in FIG. 12, various I/O devices 1214 may be coupled to first bus 1216, along with a bus bridge 1218 which couples first bus 1216 to a second bus 1220. In one embodiment, one or more additional processor(s) 1215, such as coprocessors, high-throughput MIC processors, GPGPU's, accelerators (such as, e.g., graphics accelerators or digital signal processing (DSP) units), field programmable gate arrays, or any other processor, are coupled to first bus 1216. In one embodiment, second bus 1220 may be a low pin count (LPC) bus. Various devices may be coupled to a second bus 1220 including, for example, a keyboard and/or mouse 1222, communication devices 1227 and a storage unit 1228 such as a disk drive or other mass storage device which may include instructions/code and data 1230, in one embodiment. Further, an audio I/O 1224 may be coupled to the second bus 1220. Note that other architectures are possible. For example, instead of the point-to-point architecture of FIG. 12, a system may implement a multi-drop bus or other such architecture.

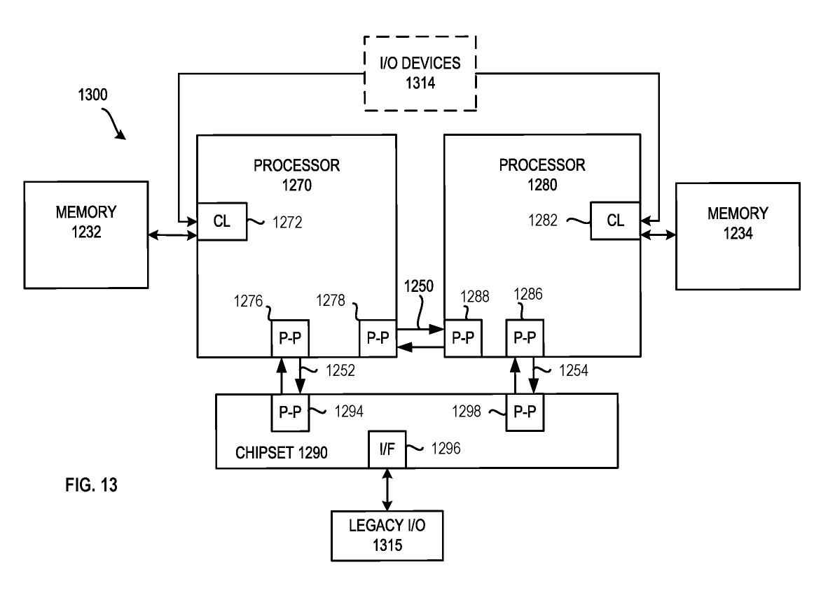

Referring now to FIG. 13, shown is a block diagram of a second more specific exemplary system 1300 in accordance with an embodiment of the present invention. Like elements in FIGS. 12 and 13 bear like reference numerals, and certain aspects of FIG. 12 have been omitted from FIG. 13 in order to avoid obscuring other aspects of FIG. 13.

FIG. 13 illustrates that the processors 1270, 1280 may include integrated memory and I/O control logic (“CL”) 1272 and 1282, respectively. Thus, the CL 1272, 1282 include integrated memory controller units and include I/O control logic. FIG. 13 illustrates that not only are the memories 1232, 1234 coupled to the CL 1272, 1282, but also that I/O devices 1314 are also coupled to the control logic 1272, 1282. Legacy I/O devices 1315 are coupled to the chipset 1290.

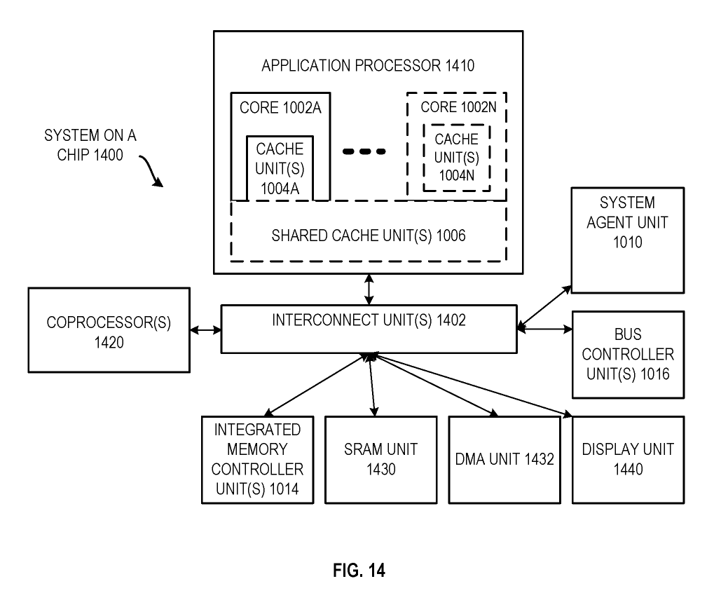

Referring now to FIG. 14, shown is a block diagram of a SoC 1400 in accordance with an embodiment of the present invention. Similar elements in FIG. 10 bear like reference numerals. Also, dashed lined boxes are optional features on more advanced. SoCs. In FIG. 14, an interconnect unit(s) 1402 is coupled to: an application processor 1410 which includes a set of one or more cores 132A-N and shared cache unit(s) 1006; a system agent unit 1010; a bus controller unit(s) 1016; an integrated memory controller unit(s) 1014; a set or one or more coprocessors 1420 which may include integrated graphics logic, an image processor, an audio processor, and a video processor; an static random access memory (SRAM) unit 1430; a direct memory access (DMA) unit 1432; and a display unit 1440 for coupling to one or more external displays. In one embodiment, the coprocessor(s) 1420 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1230 illustrated in FIG. 12, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

Emulation (Including Binary Translation, Code Morphing, Etc.)

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

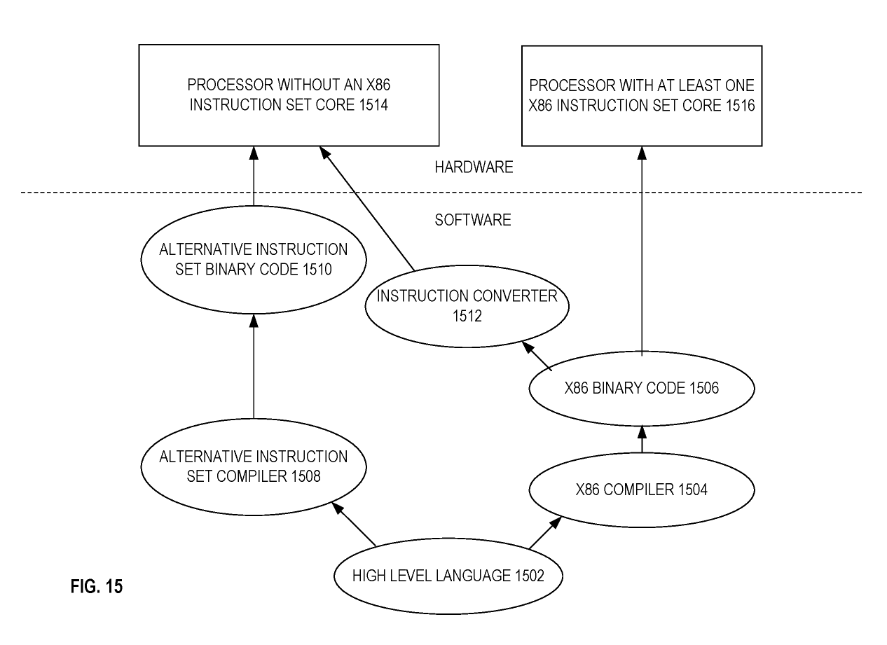

FIG. 15 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 15 shows a program in a high level language 1502 may be compiled using an x86 compiler 1504 to generate x86 binary code 1506 that may be natively executed by a processor with at least one x86 instruction set core 1516. The processor with at least one x86 instruction set core 1516 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1504 represents a compiler that is operable to generate x86 binary code 1506 (e.g., object code) that can, with or without additional linkage processing, be executed on the processor with at least one x86 instruction set core 1516. Similarly, FIG. 15 shows the program in the high level language 1502 may be compiled using an alternative instruction set compiler 1508 to generate alternative instruction set binary code 1510 that may be natively executed by a processor without at least one x86 instruction set core 1514 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1512 is used to convert the x86 binary code 1506 into code that may be natively executed by the processor without an x86 instruction set core 1514. This converted code is not likely to be the same as the alternative instruction set binary code 1510 because an instruction converter capable of this is difficult to make; however, the converted code will accomplish the general operation and be made up of instructions from the alternative instruction set. Thus, the instruction converter 1512 represents software, firmware, hardware, or a combination thereof that, through emulation, simulation or any other process, allows a processor or other electronic device that does not have an x86 instruction set processor or core to execute the x86 binary code 1506.

Components, features, and details described for any of FIGS. 4-7 may also optionally apply to any of FIGS. 2-3. Components, features, and details described for any of the processors disclosed herein (e.g., any of processors 325, a processor having load store queue 432) may optionally apply to any of the methods disclosed herein (e.g., any of methods 220, 546, 660, 770), which in embodiments may optionally be performed by and/or with such processors. Any of the processors described herein (e.g., any of processors 325, a processor having load store queue 432) in embodiments may optionally be included in any of the systems disclosed herein (e.g., any of the systems of FIGS. 11-14).

In the description and claims, the terms “coupled” and/or “connected,” along with their derivatives, may have be used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but yet still co-operate or interact with each other. For example, a load store queue may be coupled with a decode unit through one or more intervening components. In the figures, arrows are used to show connections and couplings.

The components disclosed herein and the methods depicted in the preceding figures may be implemented with logic, modules, or units that include hardware (e.g., transistors, gates, circuitry, etc.), firmware (e.g., a non-volatile memory storing microcode or control signals), software (e.g., stored on a non-transitory computer readable storage medium), or a combination thereof. In some embodiments, the logic, modules, or units may include at least some or predominantly a mixture of hardware and/or firmware potentially combined with some optional software. In the illustrations, an example separation of logic into blocks has been shown, although in some cases, where multiple components have been shown and described, where appropriate they may instead optionally be integrated together as a single component (e.g., at least some logic of the buffer entry allocation controller 334 and the decode unit 326 may optionally be merged, logic of the buffer entry allocation controller 434 may optionally be separated into components differently, etc.). In other cases, where a single component has been shown and described, where appropriate it may optionally be separated into two or more components.

The term “and/or” may have been used. As used herein, the term “and/or” means one or the other or both (e.g., A and/or B means A or B or both A and B).

In the description above, specific details have been set forth in order to provide a thorough understanding of the embodiments. However, other embodiments may be practiced without some of these specific details. The scope of the invention is not to be determined by the specific examples provided above, but only by the claims below. In other instances, well-known circuits, structures, devices, and operations have been shown in block diagram form and/or without detail in order to avoid obscuring the understanding of the description. Where considered appropriate, reference numerals, or terminal portions of reference numerals, have been repeated among the figures to indicate corresponding or analogous elements, which may optionally have similar or the same characteristics, unless specified or clearly apparent otherwise.

Certain operations may be performed by hardware components, or may be embodied in machine-executable or circuit-executable instructions, that may be used to cause and/or result in a machine, circuit, or hardware component (e.g., a processor, portion of a processor, circuit, etc.) programmed with the instructions performing the operations. The operations may also optionally be performed by a combination of hardware and software. A processor, machine, circuit, or hardware may include specific or particular circuitry or other logic (e.g., hardware potentially combined with firmware and/or software) is operative to execute and/or process the instruction and store a result in response to the instruction.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Reference throughout this specification to “one embodiment,” “an embodiment,” “one or more embodiments,” “some embodiments,” for example, indicates that a particular feature may be included in the practice of the invention but is not necessarily required to be. Similarly, in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects lie in less than all features of a single disclosed embodiment. Thus, the claims following the Detailed Description are hereby expressly incorporated into this Detailed Description, with each claim standing on its own as a separate embodiment of the invention.

### EXAMPLE EMBODIMENTS

The following examples pertain to further embodiments. Specifics in the examples may be used anywhere in one or more embodiments.

Example 1 is a processor including a decode unit to decode memory access instructions of a first type and to output corresponding memory access operations, and to decode memory access instructions of a second type and to output corresponding memory access operations. The processor also includes a load store queue coupled with the decode unit. The load store queue including a load buffer that is to have a plurality of load buffer entries, a store buffer that is to have a plurality of store buffer entries, and a buffer entry allocation controller coupled with the load buffer and coupled with the store buffer. The buffer entry allocation controller to allocate load and store buffer entries based at least in part on whether memory access operations correspond to memory access instructions of the first type or of the second type.

Example 2 includes the processor of Example 1, in which the buffer entry allocation controller, for a given memory access operation that is to correspond to a memory access instruction of the second type, is not to allocate a load buffer entry, and is not to allocate a store buffer entry.

Example 3 includes the processor of Example 1, in which the buffer entry allocation controller, for a given memory access operation that corresponds to a given memory access instruction of the second type, is to determine whether to allocate at least one of a load buffer entry and a store buffer entry.

Example 4 includes the processor of Example 3, in which the buffer entry allocation controller is to determine to allocate an entry in a respective one of the load and store buffers when current allocated entries for said respective one of the load and store buffers is below a threshold, and otherwise determine not to allocate the entry in said respective one of the load and store buffers.

Example 5 includes the processor of Example 3, in which the load store queue, when the given memory access operation includes a given load operation, is to output the given load operation without said at least one of the load and store buffer entries being allocated by the buffer entry allocation controller, when: (1) there is no dependency between the given load operation and operations that correspond to already allocated entries in the load and store buffers; and (2) resources are available to output the given load operation.

Example 6 includes the processor of any one of Examples 1 to 5, in which the buffer entry allocation controller, for each memory access operation that corresponds to a memory access instruction of the first type, is to unconditionally allocate at least one of a load buffer entry and a store buffer entry.

Example 7 includes the processor of any one of Examples 1 to 6, in which the load store queue further includes a bypass buffer coupled with the buffer entry allocation controller, the bypass buffer to have a plurality of bypass buffer entries.

Example 8 includes the processor of Example 7, in which the buffer entry allocation controller is to allocate bypass buffer entries for memory access operations that correspond to memory access instructions of the second type, but is not to allocate bypass buffer entries for memory access operations that correspond to memory access instructions of the first type.

Example 9 includes the processor of any one of Examples 7 to 8, in which the bypass buffer is to be more weakly memory ordered than the load and store buffers.

Example 10 includes the processor of any one of Examples 7 to 9, in which the bypass buffer is to have more relaxed memory dependency checking than the load and store buffers.

Example 11 includes the processor of any one of Examples 7 to 10, in which the buffer entry allocation controller, for a given load operation that corresponds to a given memory access instruction of the second type, is to allocate a bypass buffer entry for the given load operation when at least one of: (1) there is a dependency between the given load operation and at least one operation corresponding to an already allocated entry in one of the load and store buffers; and (2) resources are not currently available to output the given load operation

Example 12 includes the processor of any one of Examples 7 to 11, in which the buffer entry allocation controller, for a given store operation that corresponds to a given memory access instruction of the second type, is to allocate a bypass buffer entry for the given store operation.

Example 13 includes the processor of any one of Examples 1 to 12, in which the memory access instructions of the first type are to include at least one load instruction and at least one store instruction, and in which the memory access instructions of the second type are to include at least one of a prefetch instruction, a cache line flush instruction, a cache line write back instruction, an instruction to move a cache line between caches, and a persistent commit instruction.

Example 14 is a method performed by a processor. The method including receiving memory access instructions of a first type, and receiving memory access instructions of a second type. The method also includes allocating load buffer entries of a load buffer and store buffer entries of a store buffer for memory access operations based at least in part on whether the memory access operations correspond to the memory access instructions of the first type or the second type.

Example 15 includes the method of Example 14, in which said allocating, for a given memory access operation corresponding to a memory access instruction of the second type, includes not allocating a load buffer entry, and not allocating a store buffer entry.

Example 16 includes the method of Example 14, in which said allocating, for a given memory access operation corresponding to a given memory access instruction of the second type, includes determining whether to allocate at least one of a load buffer entry and a store buffer entry.

Example 17 includes the method of Example 16, in which said allocating includes determining to allocate an entry in a respective one of the load and store buffers when current allocated entries for said respective one of the load and store buffers is below a threshold, and otherwise determining not to allocate the entry in said respective one of the load and store buffers.

Example 18 includes the method of Example 16, further including, when the given memory access operation includes a given load operation, outputting the given load operation without allocating said at least one of the load and store buffer entries, when: (1) there is no dependency between the given load operation and operations corresponding to already allocated entries in the load and store buffers; and (2) resources are available to output the given load operation.

Example 19 includes the method of any one of Examples 14 to 18, further including allocating bypass buffer entries in a bypass buffer for memory access operations corresponding to memory access instructions of the second type, but not allocating bypass buffer entries for memory access operations corresponding to memory access instructions of the first type.

Example 20 includes the method of Example 19, further including enforcing a memory ordering model for the bypass buffer that is weaker than a memory order model enforced for the load and store buffers.

Example 21 includes the method of any one of Examples 14 to 20, in which said receiving the memory access instructions of the first type includes receiving at least one load instruction and at least one store instruction. Also, optionally in which receiving the memory access instructions of the second type includes receiving at least one of a prefetch instruction, a cache line flush instruction, a cache line write back instruction, an instruction to move a cache line between caches, and a persistent commit instruction.

Example 22 is a computer system including an interconnect, and a processor coupled with the interconnect. The processor to receive memory access instructions of a first type and memory access instructions of a second type. The processor including a load store queue including a load buffer that is to have a plurality of load buffer entries, and a store buffer that is to have a plurality of store buffer entries. The load store queue is to allocate load and store buffer entries for memory access operations based at least in part on whether the memory access operations correspond to the memory access instructions of the first type or the second type. The computer system also includes a dynamic random access memory (DRAM) coupled with the interconnect.

Example 23 includes the computer system of Example 22, in which the load store queue, for a given memory access operation that is to correspond to a memory access instruction of the second type, is not to allocate a load buffer entry, and is not to allocate a store buffer entry.

Example 24 includes the computer system of Example 22, in which the load store queue, for a given memory access operation that corresponds to a given memory access instruction of the second type, is to determine whether to allocate at least one of a load buffer entry and a store buffer entry.

Example 25 includes the computer system of any one of Examples 22 to 24, in which the load store queue further includes a bypass buffer coupled with the buffer entry allocation controller, the bypass buffer to have a plurality of bypass buffer entries. Also, optionally in which the load store queue is to allocate bypass buffer entries to memory access operations that correspond to the memory access instructions of the second type but is not to allocate bypass buffer entries to memory access operations that correspond to the memory access instructions of the first type.

Example 26 includes the processor of any one of Examples 1 to 13, further including an optional branch prediction unit to predict branches, and an optional instruction prefetch unit, coupled with the branch prediction unit, the instruction prefetch unit to prefetch instructions. The processor may also optionally include an optional level 1 (L1) instruction cache coupled with the instruction prefetch unit, the L1 instruction cache to store instructions, an optional L1 data cache to store data, and an optional level 2 (L2) cache to store data and instructions. The processor may also optionally include an instruction fetch unit coupled with the decode unit, the L1 instruction cache, and the L2 cache. The processor may also optionally include a register rename unit to rename registers, an optional scheduler to schedule one or more operations that have been decoded, and an optional commit unit to commit execution results.

Example 27 includes a system-on-chip that includes at least one interconnect, the processor of any one of Examples 1 to 13 coupled with the at least one interconnect, an optional graphics processing unit (GPU) coupled with the at least one interconnect, an optional digital signal processor (DSP) coupled with the at least one interconnect, an optional display controller coupled with the at least one interconnect, an optional memory controller coupled with the at least one interconnect, an optional wireless modem coupled with the at least one interconnect, an optional image signal processor coupled with the at least one interconnect, an optional Universal Serial Bus (USB) 3.0 compatible controller coupled with the at least one interconnect, an optional Bluetooth 4.1 compatible controller coupled with the at least one interconnect, and an optional wireless transceiver controller coupled with the at least one interconnect.

Example 28 is a processor or other apparatus operative to perform the method of any one of Examples 14 to 21.

Example 29 is a processor or other apparatus that includes means for performing the method of any one of Examples 14 to 21.

Example 30 is a processor or other apparatus that includes any combination of modules and/or units and/or logic and/or circuitry and/or means operative to perform the method of any one of Examples 14 to 21.

Example 31 is a processor or other apparatus substantially as described herein.

Example 32 is a processor or other apparatus that is operative to perform any method substantially as described herein.

What is claimed is:

1. A processor comprising:
a decode unit to decode memory access instructions of a first type and to output corresponding memory access operations, and to decode memory access instructions of a second type and to output corresponding memory access operations; and
a load store queue coupled with the decode unit, the load store queue including:
a load buffer that is to have a plurality of load buffer entries;
a store buffer that is to have a plurality of store buffer entries; and
a buffer entry allocation controller coupled with the load buffer and coupled with the store buffer, the buffer entry allocation controller to allocate load and store buffer entries based at least in part on whether memory access operations correspond to memory access instructions of the first type or of the second type.

2. The processor of claim 1, wherein the buffer entry allocation controller, for a given memory access operation that is to correspond to a memory access instruction of the second type, is not to allocate a load buffer entry, and is not to allocate a store buffer entry.

3. The processor of claim 1, wherein the buffer entry allocation controller, for a given memory access operation that corresponds to a given memory access instruction of the second type, is to determine whether to allocate at least one of a load buffer entry and a store buffer entry.

4. The processor of claim 3, wherein the buffer entry allocation controller is to:
determine to allocate an entry in a respective one of the load and store buffers when current allocated entries for said respective one of the load and store buffers is below a threshold; and
otherwise determine not to allocate the entry in said respective one of the load and store buffers.

5. The processor of claim 3, wherein the load store queue, when the given memory access operation comprises a given load operation, is to output the given load operation without said at least one of the load and store buffer entries being allocated by the buffer entry allocation controller, when: (1) there is no dependency between the given load operation and operations that correspond to already allocated entries in the load and store buffers; and (2) resources are available to output the given load operation.

6. The processor of claim 1, wherein the buffer entry allocation controller, for each memory access operation that corresponds to a memory access instruction of the first type, is to unconditionally allocate at least one of a load buffer entry and a store buffer entry.

7. The processor of claim 1, wherein the load store queue further comprises a bypass buffer coupled with the buffer entry allocation controller, the bypass buffer to have a plurality of bypass buffer entries.

8. The processor of claim 7, wherein the buffer entry allocation controller is to allocate bypass buffer entries for memory access operations that correspond to memory access instructions of the second type, but is not to allocate bypass buffer entries for memory access operations that correspond to memory access instructions of the first type.

9. The processor of claim 7, wherein the bypass buffer is to be more weakly memory ordered than the load and store buffers.

10. The processor of claim 7, wherein the bypass buffer is to have more relaxed memory dependency checking than the load and store buffers.

11. The processor of claim 7, wherein the buffer entry allocation controller, for a given load operation that corresponds to a given memory access instruction of the second type, is to allocate a bypass buffer entry for the given load operation when at least one of: (1) there is a dependency between the given load operation and at least one operation corresponding to an already allocated entry in one of the load and store buffers; and (2) resources are not currently available to output the given load operation

12. The processor of claim 7, wherein the buffer entry allocation controller, for a given store operation that corresponds to a given memory access instruction of the second type, is to allocate a bypass buffer entry for the given store operation.

13. The processor of claim 1, wherein the memory access instructions of the first type are to include at least one load instruction and at least one store instruction, and wherein the memory access instructions of the second type are to include at least one of a prefetch instruction, a cache line flush instruction, a cache line write back instruction, an instruction to move a cache line between caches, and a persistent commit instruction.

14. A method performed by a processor, the method comprising:
receiving memory access instructions of a first type;
receiving memory access instructions of a second type; and
allocating load buffer entries of a load buffer and store buffer entries of a store buffer for memory access operations based at least in part on whether the memory access operations correspond to the memory access instructions of the first type or the second type.

15. The method of claim 14, wherein said allocating, for a given memory access operation corresponding to a memory access instruction of the second type, comprises not allocating a load buffer entry, and not allocating a store buffer entry.

16. The method of claim 14, wherein said allocating, for a given memory access operation corresponding to a given memory access instruction of the second type, comprises determining whether to allocate at least one of a load buffer entry and a store buffer entry.

17. The method of claim 16, wherein said allocating comprises:
determining to allocate an entry in a respective one of the load and store buffers when current allocated entries for said respective one of the load and store buffers is below a threshold; and
otherwise determining not to allocate the entry in said respective one of the load and store buffers.

18. The method of claim 16, further comprising, when the given memory access operation comprises a given load operation, outputting the given load operation without allocating said at least one of the load and store buffer entries, when: (1) there is no dependency between the given load operation and operations corresponding to already allocated entries in the load and store buffers; and (2) resources are available to output the given load operation.

19. The method of claim 14, further comprising allocating bypass buffer entries in a bypass buffer for memory access operations corresponding to memory access instructions of the second type, but not allocating bypass buffer entries for memory access operations corresponding to memory access instructions of the first type.

20. The method of claim 19, further comprising enforcing a memory ordering model for the bypass buffer that is weaker than a memory order model enforced for the load and store buffers.

21. The method of claim 14, wherein said receiving the memory access instructions of the first type comprises receiving at least one load instruction and at least one store instruction, and wherein receiving the memory access instructions of the second type comprises receiving at least one of a prefetch instruction, a cache line flush instruction, a cache line write back instruction, an instruction to move a cache line between caches, and a persistent commit instruction.

22. A computer system comprising:
an interconnect;
a processor coupled with the interconnect, the processor to receive memory access instructions of a first type and memory access instructions of a second type, the processor comprising:
a load store queue including:
a load buffer that is to have a plurality of load buffer entries;
a store buffer that is to have a plurality of store buffer entries; and
wherein the load store queue is to allocate load and store buffer entries for memory access operations based at least in part on whether the memory access operations correspond to the memory access instructions of the first type or the second type; and
a dynamic random access memory (DRAM) coupled with the interconnect.

23. The computer system of claim 22, wherein the load store queue, for a given memory access operation that is to correspond to a memory access instruction of the second type, is not to allocate a load buffer entry, and is not to allocate a store buffer entry.

24. The computer system of claim 22, wherein the load store queue, for a given memory access operation that corresponds to a given memory access instruction of the second type, is to determine whether to allocate at least one of a load buffer entry and a store buffer entry.

25. The computer system of claim 22, wherein the load store queue further comprises a bypass buffer coupled with the buffer entry allocation controller, the bypass buffer to have a plurality of bypass buffer entries, and wherein the load store queue is to allocate bypass buffer entries to memory access operations that correspond to the memory access instructions of the second type but is not to allocate bypass buffer entries to memory access operations that correspond to the memory access instructions of the first type.
